(19) United States
(12) Patent Application Publication
(10) Pub. No.: US 2008/0061191 A1
(43) Pub. Date: Mar. 13, 2008

(54) Multi-functional high energy plasma aircraft and nuclear fusion system to produce energy from a controlled nuclear fusion reaction

(76) Inventor: Gary Richard Gochnour, Seattle, WA (US)

Correspondence Address: Gary Richard Gochnour, Apt Nr 426, 747 N. 135th Street, Seattle, WA, 98133, US

(21) Appl. No.: 11/728,080

(22) Filed: Mar. 23, 2007

Related U.S. Application Data
(63) Continuation-in-part of application No. 11/137,643, filed on May 25, 2005, now abandoned.
Application No. 11/137,643 is a continuation-in-part of application No. 10/841,702, filed on May 6, 2004, now abandoned.
(60) Provisional application No. 60/468,598, filed on May 6, 2003.

(51) Int. Cl. B64G 1/40

(52) U.S. Cl. 244/171.5

(57) ABSTRACT

The invention relates to a plasma based aircraft maintained in a flight mode by either post nuclear fusion reaction plasma contained rotating vortices above and beneath said aircraft, or a pre-nuclear fusion reaction aircraft flight mode comprising use of said rotating vortices and a plasma gun when needed. Said aircraft is comprised of chromium steel, or higher ferrochromium steel can be used. Said aircraft requires no external fuel source, said aircraft receives energy from aircraft produced plasma and electric energy. Starting energy is stored in aircraft capacitance system. Said craft is capable of space flight, use as a submersible craft, boring device, or lifting device. Said aircraft can also be utilized in an artificial domed environment to produce heat, light, a light mist, energy, and can regenerate an atmosphere, and produce an atmosphere, and other uses. Said craft does not require an external source of fuel for space flight or for submersible use. Particle propulsion in space will be used utilizing metal ions stored in said craft capacitor plates. Said craft is opaque, invisible within the visible spectrum, and invisible to electromagnetic radiation, and absorbs radiation it produces. Said aircraft is capable of verticle ascent, descent and landing. Said aircraft can operate within earth radiation belts safely, and for extended periods of time. Said aircraft with two larger aircraft comprised of magnesium aluminum material, can achieve ignition of a B-11 fusion spherical plasma, formed by smaller craft electrolysis system, with no radiation or cooling required and store produced energy in craft plasma vortices.

### CROSS-REFERENCE TO RELATED APPLICATIONS

This application is a continuation in part of Ser. No. 11/137,643 filed May 25, 2005, by present inventor, which was a continuation in part of Ser. No. 10/841/702, filed 2004, May 6, by present inventor, now abandoned, which claims the priority to provisional patent application Ser. No. 60/468,598, filed 2003, May 6, by the present inventor.

### BACKGROUND OF THE INVENTION

1. Field of Invention

This invention relates to a new type multi-functional electromagnetic, plasma based aircraft, capable of operation in the atmosphere as an aircraft, underwater as a submersible craft, in outer space as a space craft, or as a boring device, or a lifting device.

A number of the aircraft described, utilized together, are able to be used in a process with a resultant B-11 isotope ion nuclear fusion reaction to obtain electricity. Said reaction is considered a radiation free nuclear fusion reaction, with minimal danger from heat.

Negligible radiation will be produced in the fusion process, only charged particles.

This aircraft does not require fuel to be provided for aircraft operation, this craft has no moving parts other than ailerons.

2. Objects and Advantages

This invention will make possible travel in space at small cost. Depletion of the world's resources will no longer be a problem. This invention is on a par with the discovery of fire, insofar as man's future is concerned, and is also a decontamination device.

### SUMMARY OF THE INVENTION

In the present invention, an aircraft operates within a plasma environment of charged particles, said particles are rotating around the craft within an atmosphere.

In immediate outer space, the exosphere and above, and within outer space, an alternative propulsion system will be used.

Within an atmosphere of gases, the aircraft operations will be performed in a hyperdynamic plasma state.

The fusion energy portion of this utility patent, utilizes the aircraft in a fusion process. No fuel is required, only ions.

In the aircraft of present invention, charged particles will be produced off an annular ring of blades around aircraft, primarily from conducting wires heated to high temperatures due to resistance. Departing particles will interact with the ambient atmosphere producing more ions. A large quantity of plasma will be produced off the ring of blades. Individual blades within the annular ring of blades around the circumferential mid-section of the aircraft, possess conducting, uninsulated field windings, comprised of the material tungsten, in preferred embodiment.

Said aircraft has no moving parts, except for the ailerons. In the present invention, charged particles comprising electrons and charged ions, also called energetic charged particles, will be placed into Larmor gyro orbiting particles fields around the aircraft, as rotating plasma vortices. Said orbiting particle fields, rotating, circling said ferromagnetic aircraft, will raise the aircraft to high magnetic fields, and consequent high electric and plasma fields.

In the present invention, an orbiting particle field, possessing a rotational direction for upward motional movement, will lift the aircraft off the ground or other surface, into the air, using a plasma gun, if necessary.

In the present invention, navigation of the aircraft will be by means of utilizing said blades, as ailerons. Said ailerons wrapped by said conducting field windings possess an electric charge within the orbiting particle fields, and by use of rotating plasma vortices for propulsion, the aircraft will be placed in direction of travel by means of the ailerons, or said plasma gun.

In the present invention, only remnant energy from last operation of aircraft, said remnant energy stored in craft oscillatory circuit, sufficient to begin operaton of craft, will be required to start aircraft. No fuel is required, only energy from air.

In the present invention, the aircraft will produce all the energy required to operate aircraft from aircraft plasma fields, and oscillatory circuit, to include producing said energy.

In the present invention, the aircraft, with a number of similar aircraft, can produce electric energy from nuclear fusion process.

In this invention, the aircraft can be used as an aircraft, a spacecraft, submersible craft, boring or lifting device, or by a particle propulsion system in space, this aircraft can regularly journey to Mars and some of the asteroids in the asteroid belt, at, in effect, negligible, or no cost.

### BRIEF DESCRIPTION OF THE DRAWINGS

FIG. 1 is a side view of the aircraft showing lenticular shape of aircraft. Also shown is a side view of the annular bladed ring assembly encircling the aircraft and extending out from the sides of the aircraft, three landing gear, a window for pilot and copilot, and the top and bottom plasma vortices.

FIG. 2 is a top plan view of the aircraft showing the circular configurations of aircraft, and the annular bladed ring assembly.

FIG. 3 is a bottom plan view of the aircraft showing the circular configuration of aircraft, the bottom of the annular bladed ring assembly, the three landing gear, and a soft-landing surface on bottom of aircraft. Also shown weak current entrance and strong current exit. Field windings are shown in a longitudinal position, a blade core for field windings is shown, and blade notches for field windings on a blade.

FIG. 4 is a top plan view showing capacitor, electric system attached to top plan surface of bottom half of aircraft hull, and the same top plan view showing the top of annular bladed ring assembly.

FIG. 5 is a cross section side view of the aircraft showing an ion acceleration system and the central shaft containing an inductance coil, annular bladed ring assembly, capacitor system, electrolysis system, crew cabin doors for access to upper deck and lower deck through said central shaft, crew hatch doors for entering or exiting craft through the central shaft, and a pilot area and pilot aircraft controls, and an engineer area and diagnostic controls for plasma and electric systems.

FIG. 6A is a diagram showing the space between the upper and lower hulls for attachment of ailerons to multi-bladed annular ring.

FIG. 6B is a side view of the opening between the aircraft hulls to extract worn or burnt ailerons, or to attach repalcement ailerons.

FIG. 6C is a side view of the aircraft using particle impact on ailerons to determine banking direction.

FIG. 6D is a side view of the aircraft using particle impact on ailerons to determine banking direction.

FIG. 6E is a side view of the aircraft. The charged particles are impacting ailerons on bottom surface. The aircraft will rise in altitude.

FIG. 6F is a side view of the aircraft using particle impact on ailerons to determine altitude direction. Particles will impact top surface of ailerons. The aircraft will descend.

FIG. 7A is a side view of an aircraft within rotating vortices. Ailerons have determined the position for direction of travel. Increase in rotation of vortices will propel the aircraft diagonal to earth.

FIG. 7B is a side view of an aircraft within rotating vortices being propelled horizontal with earth.

FIG. 7C is a side view of an aircraft within rotating vortices. Increase in rotation of vortices will propel the aircraft vertical to earth.

FIG. 8A is a top view of the extricated capacitor system from aircraft, showing combined negative charge of capacitors used as electrodes for propulsion, is moving aircraft away from lesser positive charged electrode, in direction of arrow.

FIG. 8B is a top view of extricated capacitor system from aircraft. Combined positive charge greater than negative is moving craft away from negative charge in direction of arrow.

FIG. 9A is a cutaway top view of aircraft with a plasma gun ejecting plasma toward the rear of craft. Craft will be propelled in direction of arrows.

FIG. 9B shown is a cutaway top view of aircraft with a plasma gun. Plasma is being ejected into a central shaft, and out the bottom of craft. Craft will be propelled upward, away from earth.

FIG. 9C shown is a side view of aircraft. FIG. 9C is a side view of FIG. 9B. Plasma is shown ejected from bottom of craft. Craft will be propelled in direction of arrows, upward and away from the earth due to the rotating plasma vortices and ejected plasma.

FIG. 9D shown is a cutaway top view of aircraft used as a space craft. Utilizing alternating current from the fluctuating direct current of the aircraft, charged particles will be ejected from aircraft utilizing propulsion tube between a large and a small capacitor, as shown. Movement will be in direction of arrows.

FIG. 9E shown is a cutaway top view of aircraft used as a submersible craft within water. Ions off uninsulated conducting ailerons used as fixed rotating propellers, will interact with surrounding conducting water with a Lorentz force propelling aircraft by synchronous movement of propellers in desired direction of travel.

FIG. 9F shown is a side view of aircraft used as a boring device with a protruding, rotating drill attached through center of craft.

FIGS. 9G is a side view of craft used as a lifting device. Cables are hung from below blade assembly ring, to hoist load.

FIG. 10 is a side view of aircraft in electric force propulsion mode interacting with Earth's magnetic field.

FIG. 11A is a top perspective view depicting the top surface of aircraft hull, showing exit electrodes for energized, decomposed fusion fuels for formation of a B-11 isotope ion fusion spherical plasma. Also shown is an outline of the annular ring.

FIG. 11A is a side view of aircraft showing raised pyramid and ion acceleration system, and ball electrode.

FIG. 12A is a side view of three aircraft positioned to effect a B-11 isotope ion nuclear fusion reaction.

FIG. 12B is a side view of the fusion spherical plasma and two adjacent plasmas, showing directions of each individual plasma's rotation.

FIG. 12C is a top view of the induced Larmor orbiting particle plasma field, and a top view of the B-11 isotope ion spherical plasma, completely encircled now by the narrowing orbits of the induced perpendicualr particle field. Extreme ignition temperature required for B-11 reaction is being approached.

FIG. 12D is a top plan view of the array of containment barrels and electrodes for electrolysis, and also showing the inner wall and floor for the lower deck.

FIG. 12E is a perspective view from the side of a cutaway view of an array of containment barrels for electrolysis procedure by electrode, and an electrolysis system with an ion acceleration system for exiting particles for formation of fusion spherical plasma.

FIG. 13 is a side view of three aircraft positioned to effect a B-11 isotope ion nuclear fusion reaction, close to moment of ignition of spherical plasma.

FIG. 14 is a B-11 spherical plasma between the three aircraft in the process of ignition by land based laser and, or, neutral beam, and grounded to railroad tracks and high power tension lines.

FIG. 15 shows end phase of fusion process. The produced energetic charged particles are now stored in craft rotating plasma vortices. Shown in FIG. 15 are remnant electrostatic particles and electrons and charged particles, being collected by extended rods. Said craft are shown grounded to the depicted railroad tracks.

### DESCRIPTION OF THE PREFERRED EMBODIMENT

### Operation of Aircraft

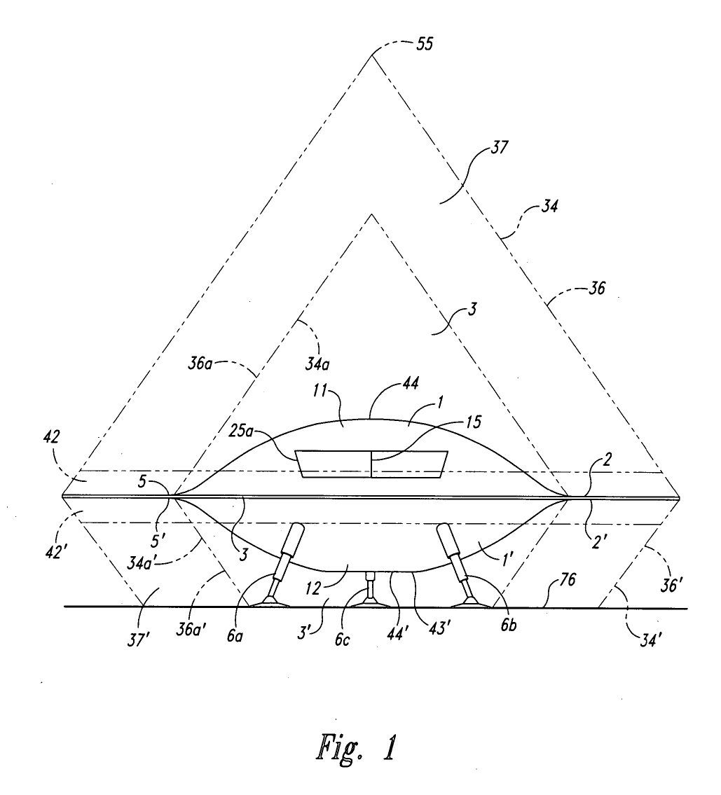

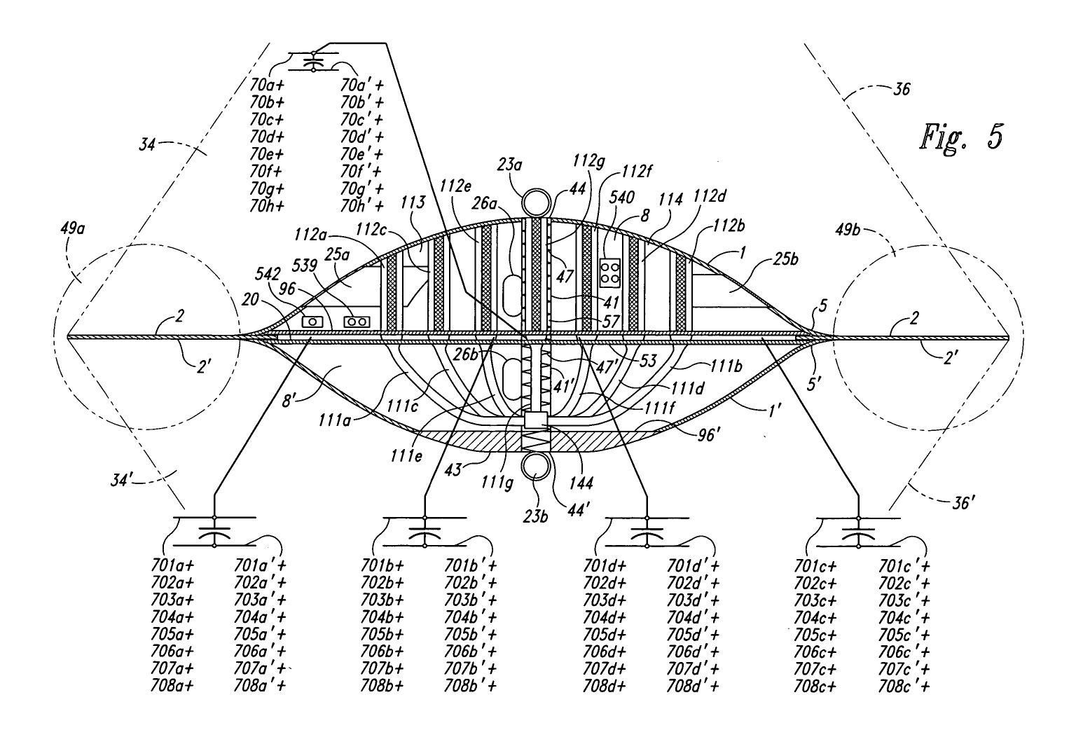

The operation of the aircraft as a system and device will be described first. Said aircraft being the central device. This will be followed by a description of the preferred embodiment pertaining to aircraft. Next a process portion of this utility patent will describe a process producing rotating plasma vortices 34, 34′ and 34a, 34a′, FIG. 1, on the top and bottom surfaces of an annular ring of blades 2, 2′, FIG. 1, around said aircraft. Next, a process portion of this patent will describe a fusion energy process utilizing said aircraft. Said processes will be described first, followed by descriptions relating to the preferred embodiment for referenced processes. The aircraft is comprised of the material chromium steel in present invention, higher ferrochromium steel is also a recommended material for said aircraft. When starting operation, the remnant magnetism in the ferromagnetic hull 1, 1′, FIG. 1 of said craft 1, 1′, will be further magnetized from an array of capacitors FIG. 5 connected in parallel within an oscillatory circuit containing inductance and resistance. Said resistance being provided by uninsulated tungsten-field windings around blade cores, connected to insulated copper wiring, preferred embodiments for wiring as specified.

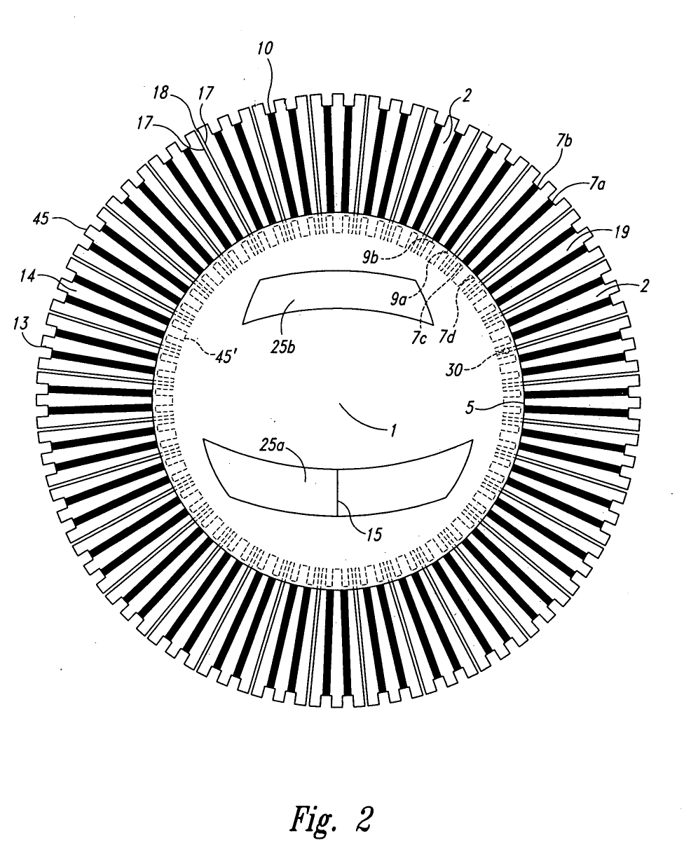

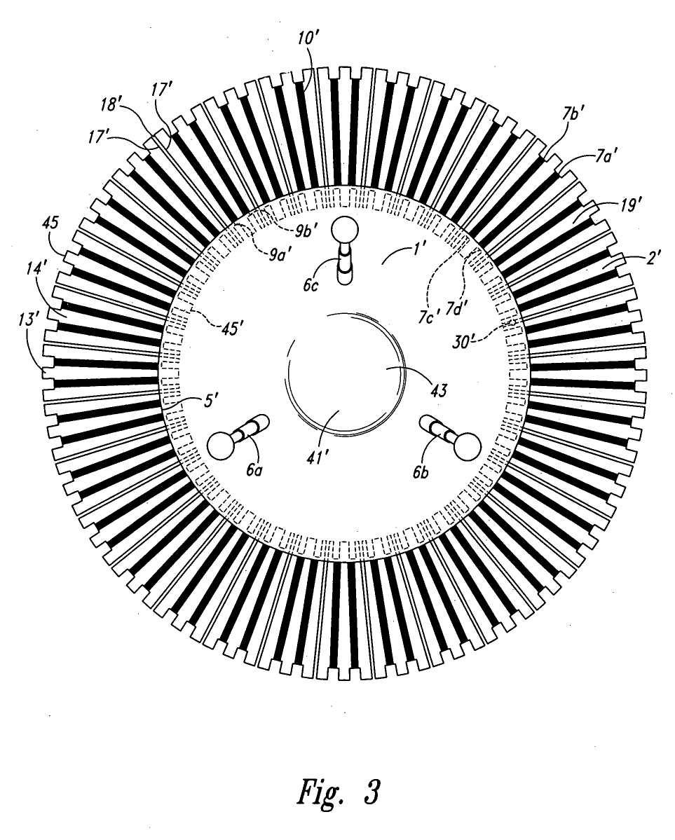

Said starting charge from the capacitors through the inductance coil, establishes an applied magnetic field around the aircraft, with a north pole 11, FIG. 1, and a south pole 12, FIG. 1, around the aircraft. At the same time, said capacitor system will provide a weak current 9a and 9a′, FIGS. 2 and 3, through uninsulated field windings 10, 10′, FIGS. 2 and 3, around blade cores 19, 19′, FIGS. 2 and 3, within an array of blades 2, 2′, FIGS. 2 and 3, encircling the aircraft. Thirty two blades is preferred embodiment for the number of blades in said annular ring of blades. Tungsten material is preferred embodiment for material for said field winding wire, producing a large number of free ions on uninsulated wire surfaces of the field windings.

Ions will be freed with current through said uninsulated field windings.

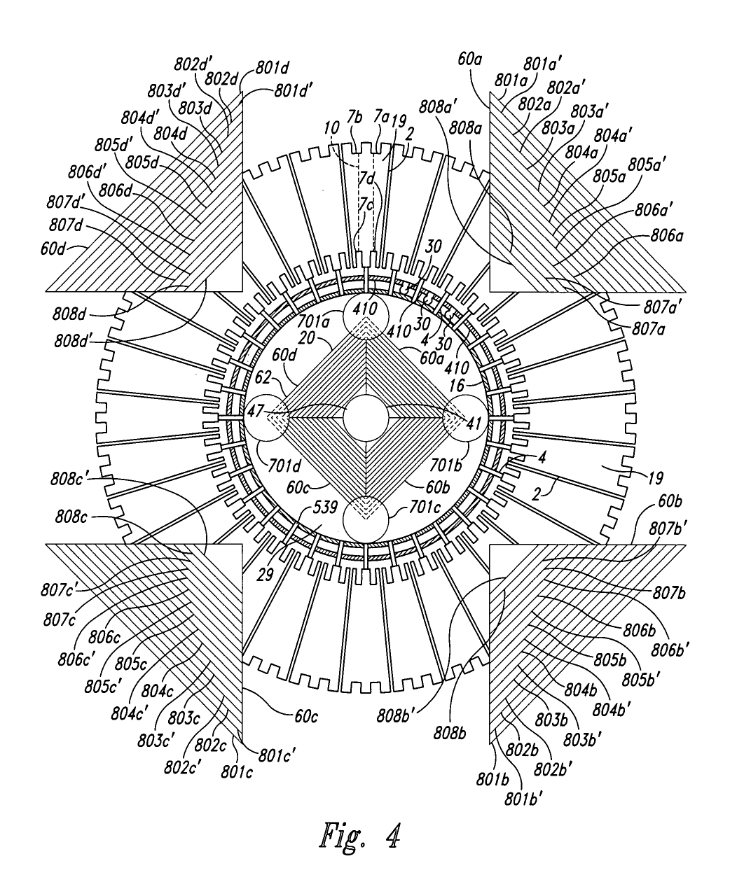

Said ions will be produced in abundance off the tungsten field windings. Said tungsten wire will be raised to high temperatures due to resistance within the tungsten field windings, the current into the tungsten wire coming from the more conductive copper wire in the electric system 20, FIG. 4.

Upon being energized by said current, the ions will depart the annular ring of blades at a voltage recognized to energize ions, protons attracted to north pole, electrons to south pole, mostly.

As the craft has a developed magnetic and electric field, said fields being at right angles to each other, the ions will be projected by a Lorentz force at right angles to the magnetic and electric fields, said fields being at right angles to each other, and then projected into perpendicular Larmor gyro orbiting fields, forming vortices 34, 34a, and 34′, 34a′, FIG. 5, around aircraft.

The more energetic particles will manifest narrowing orbits, over time, within the Larmor plasma particle fields, contributing to forming funnel shaped plasma vortices.

Said plasma vortices will form on both the top and bottom surfaces of said annular bladed ring assembly 2, 2′, FIGS. 2 and 3.

Due to a stronger electrical capacitance system within the oscillatory circuit than the magnetic based inductance system, and due to the diamagnetic plasma current to the right, the positive particles, primarly protons, will be pulled to the right. When viewing both the top plasma vortex and the bottom plasma vortex, from the ground looking up, both vortices will be turning counterclockwise. By the right hand rule, this is a motional direction of movement for upward movement, and with ejected plasma, craft will lift off the earth and become airborne. The ailerons will be used to point the aircraft in the desired direction of travel. The electrical system will impart increased energy to the plasma vortices, and with the plasma gun 9A, and through increased current through the annular bladed ring assembly 2, 2′, aircraft will accelerate in desired direction of travel.

The Larmor gyro orbiting particle field is also a plasma field, a diamagnetic, moving magnetic field. Said fields form the rotating funnel shaped plasma vortices 34, 34a, and 34′, 34a′, FIG. 1. The top surface of the bottom funnel shaped plasma vortice 34′ and 34a′, and the bottom surface of the top funnel shaped plasma vortice 34 and 34a, FIG. 1, passing over the top and bottom surfaces of said conducting field windings 10, FIG. 2, and 10′, FIG. 3, on said fixed array of blades, generates electricity. Said field windings also conduct the alternating current component of the flux of the fluctuating direct current of the fixed poles of aircraft magnetic field as well as the flux of the moving diamagnetic plasma current.

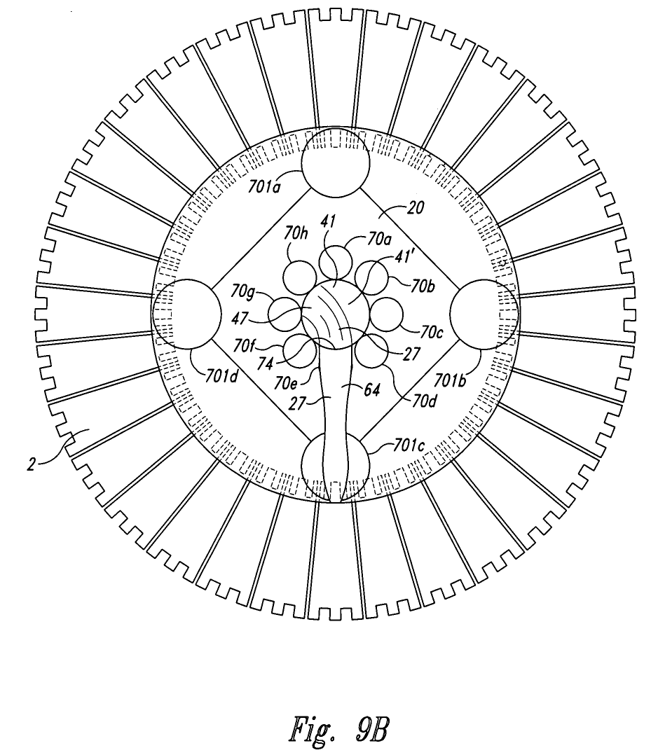

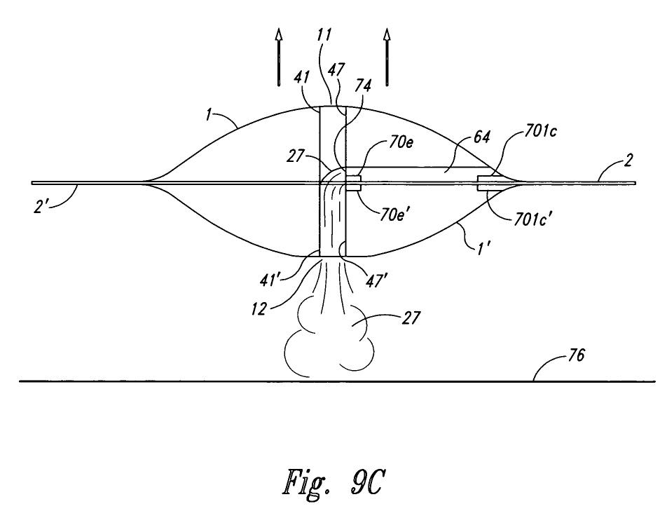

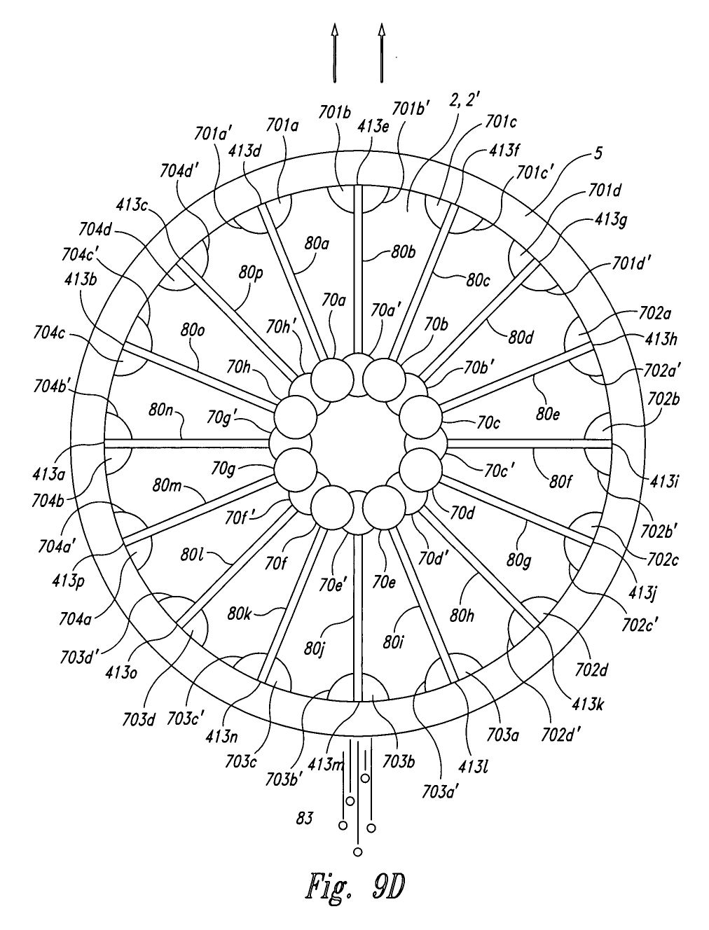

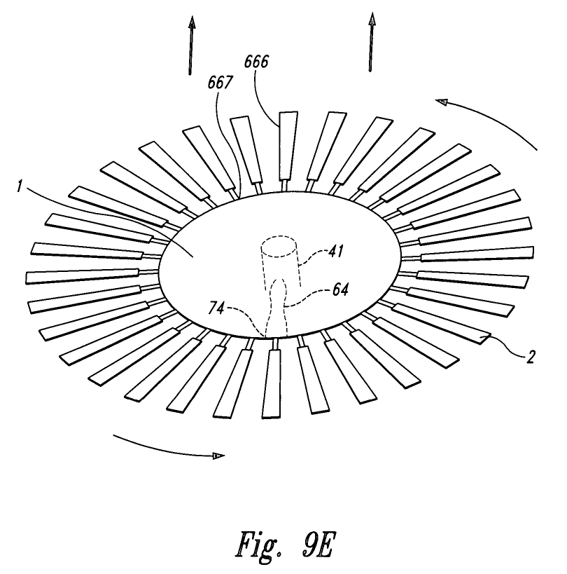

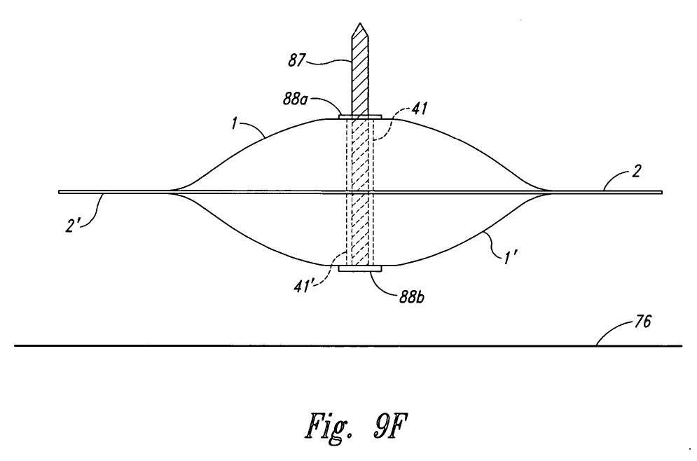

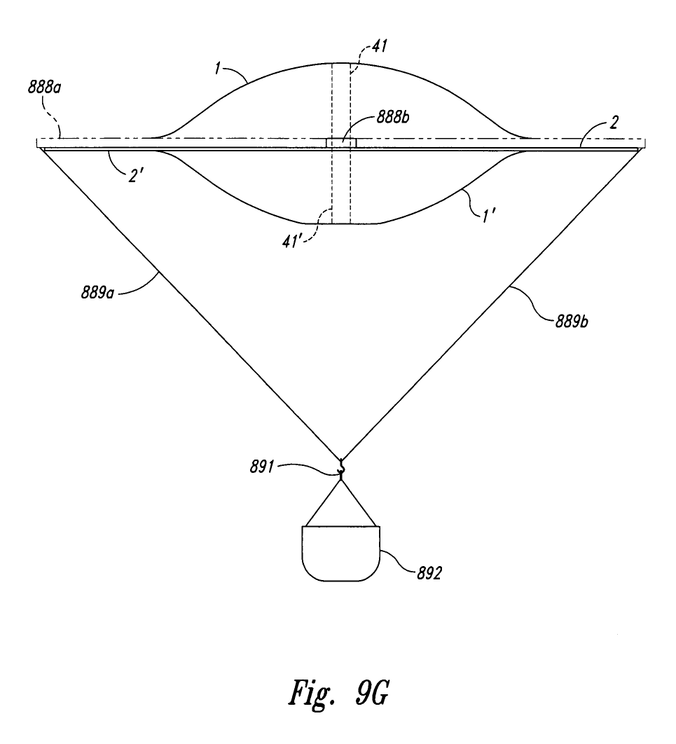

The strong current exiting 9b, FIG. 2 and 9b′, FIG. 3, will be stored within the aircraft capacitance inductance system. Said aircraft also possesses an oscillatory circuit. Usually an oscillatory circuit loses energy as it emits some, or all energy as electromagnetic radiation out the ends of the inductance coil. Within this system, the aircraft plasma system and oscillatory circuit, the overarching plasma vortices 34, 34′ and 34a, 34a′, FIG. 1, covered by a Langmuir sheath 36, 36′ and 36a, 36a′, FIG. 1, will reabsorb this radiation, the emitted radiation 44, 44′, FIG. 5.

The area under the plasma vortices is a vacuum area, extending from the inside surface of the plasma, 36a, 36a′, FIG. 1, to the hull surface, 1, 1′, FIG. 1. The radiation emitted from the inductance coil 47, 47′, FIG. 5, also called electric coil, is usually lost in whole, or in part. Within this system said emitted radiation 44, 44′, FIG. 5, is reabsorbed in its entirety. Plasmas absorb all electromagnetic radiation, to include the radiation they produce, they will be invisible to the human eye within the visible spectrum. Plasmas are opaque to electromagnetic radiation except by the magnetic poles of the craft where the light is polarized.

Said aircraft does not require fuel to be provided for aircraft to operate. Energy is obtained nondepleting from the atmosphere or the environment as electrons and ions. This craft could use Martian atmosphere, C₂O₃, best with its plasma gun.

The Larmor orbiting particles, a diamagnetic moving plasma, are in orbits around the aircraft, increasing in energy to the speed of light. Said rotating plasma field is part of the oscillatory circuit of the craft. Said plasma is an oscillatory, inhomogeneous plasma, similar to a magnetically contained, confined, homogeneous plasma, in that both fields can contain a spherical plasma. The magnetically confined spherical plasma for a transitory period of time, the oscillatory, inhomogeneous plasma, for much longer. Nonhyperdynamic equations from craft electromagnetic oscillatory system, can be used in lieu of the unascertainable equations of the hyperdynamic, inhomogeneous plasma, to control the field. Both oscillatory systems, the electric capacitor system, and the magnetic inductance system, are connected. Also connected are the plasma vortices through the common annular bladed ring system with its uninsulated field windings, and the inductance system.

Said field windings connect both systems, the oscillatory circuit and the plasma vortices. The electromagnetic equations from the oscillatory circuit can be used to control the rotating plasma vortices as the plasma equations are hyperdynamic and not subject to control at this time. In effect, the plasma equations are unascertainable at this time due to multiple factors at or near the speed of light.

Energy can be taken out of the rotating plasma vortices, and placed into the capacitance inductance system, or conversely, energy can be taken out of the capacitance inductance system, and placed into said rotating plasma vortices. An increase of energy to the vortices, increases speed of craft, a decrease of energy, decreases speed. An increase in energy to vortices leads to an increase in rotation of the aircraft vortices, which leads to an increase in speed of craft. It also leads to a lengthening of the plasma vortices. The capacitance electric system controls the plasma vortices. The plasma gun assists propulsion as needed.

The preferred embodiment for the capacitors in the capacitance system is eight sets of four large capacitors connected in parallel as shown in FIGS. 4 and 5, a total of 64 capacitor plates, 32 sets. Though eight sets of four capacitors is only eight times as great as one set of four capacitors, it has 80 times as much magnetic force when said capacitors are connected in parallel. A single set of the top four capacitors, one set of four capacitors, is depicted in FIG. 4, capacitors 701a, 701b, 701c, and 701d. Additionally, eight smaller capacitors connected in parallel, 70a, 70b, 70c, 70d, 70e, 70f, 70g and 70h, are depicted in FIG. 9 arrayed around central shaft 41, FIG. 9. Eight small capacitors is preferred number of small capaciitors.

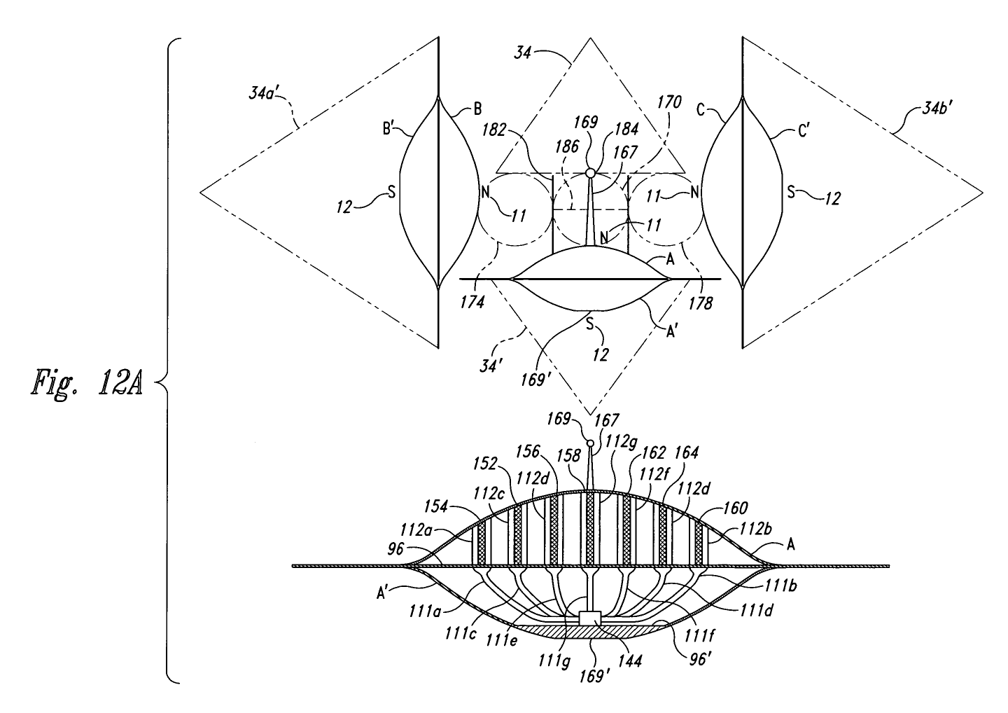

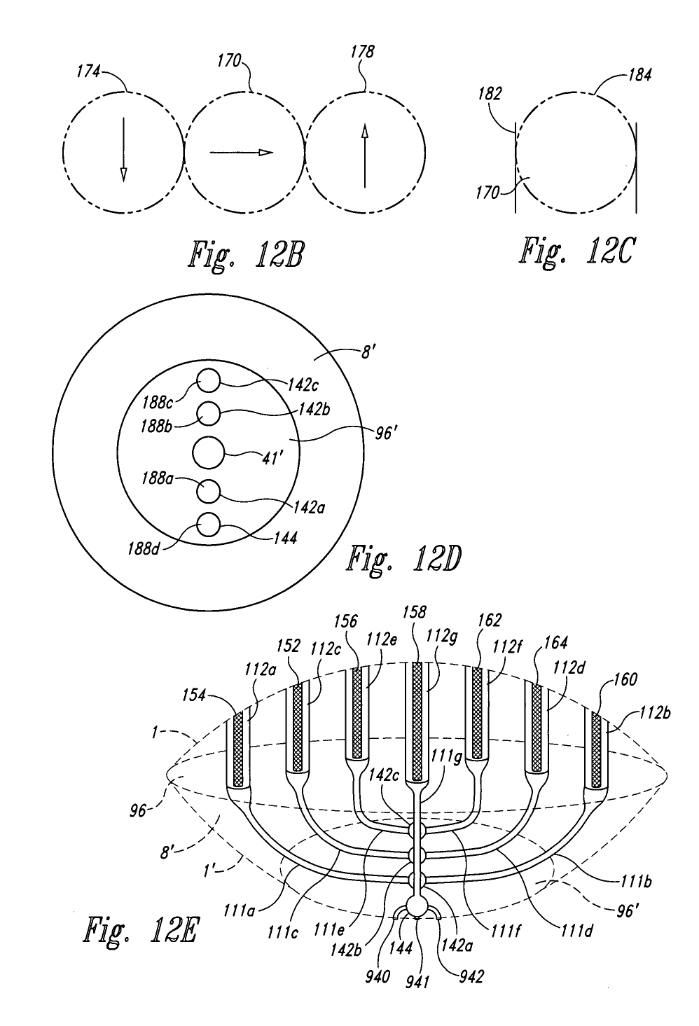

The following aircraft systems will be connected in sequence: Bladed ring assembly 2, 2′, FIGS. 2 and 3, blade axel system 4, FIG. 4, a blade attachment ring 16, FIG. 4, the plurality of large capacitors 701a, 701b, 701c, 701d, and 702a, 702b, 702d, and 703a, 703b, 703c, 703d, and 704a, 704b, 704c, 704d, and 705a, 705b, 705c, 705d, and 706a, 706b, 706c, 706d, and 707a, 707b, 707c, 707d, and 708a, 708b, 708c, and 708d, FIG. 5 and small capacitors 70a, 70b, 70c, 70d, 70e, 70f, 70g, 70h, inductance coil, also called electric coil 47, 47′, FIG. 5, and the interconnected connected electric system 20, FIGS. 4 and 5. Said electric coil will be comprised of thick coils. Thick metallic coils are preferred embodiment. Also within the electric system 20, is the electrolysis system and electrodes 188a, 188b, 188c, FIG. 12D.

An array of ferromagnetic cores within electrolysis system will increase in magnetic intensity due to electrolysis electrodes producing orbiting electrons and particles. During a fusion process, the requirement for energized particles to be placed into mini-Larmor orbits around said ferromagnetic cores within the electrolysis system, will require, after initial formation of orbiting mini-Larmor particle fields, that the particles, primarily protons, electrons and B-11 isotope ions, have to be maintained in orbit around the ferromagnetic cores, increasing magnetic intensity of cores, and particles, as well.

At the onset of the fusion process, the cores will have increased in magnetic intensity to permit formation of the mini-Larmor orbits that will persist after the charged particles exit from roof of aircraft. The orbiting particle miniature funnels, will decompose, and the spiraling, exiting particles will coalesce into a spherical plasma, on roof of the aircraft.

Electromagnetic radiation 44, 44′, FIG. 5, emitted from top and bottom of craft from inductance coil, will be absorbed, in large part, by the overarching plasma vortices 34, 34′ and 34a, 34a′, FIG. 1. Said overarching plasma vortices are covered by a Langmuir sheath 36, 36′ and 36a, 36a′, FIG. 1. Said overarching plasma vortices and Langmuir sheath, can absorb said electromagnetic radiation emitted by the inductance coil. When referring to plasma vortices, it can be assumed they are covered by a Langmuir sheath as this occurs naturally.

Said electromagnetic systems will be accompanied by plasma systems operating concurrently, said plasma systems include: vortex plasma produced by the uninsulated annular ring 2, 2′, said plasma utilized by a plasma gun 64, FIG. 9A, said plasma gun can also utilize plasma produced by said small capacitors encircling the central shaft 47, FIG. 9A, and the plasma produced by large capacitors. Said plasma produced by large capacitors is used in large part in formation of plama fields 34, 34′ and 34a, 34a′, FIG. 1. The uninsulated annular ring 2, 2′, produces most plasma.

The plasma produced by internal electrolysis system FIG. 12E, producing ions and also electrons. The plasma gun FIG. 9A and FIG. 9C, will have a large pulsed current, as the fluctuating direct current of the aircraft, with the large array of capacitors, produces a powerful plasma system for the plasma gun, also called plasma tube. Said plasma gun will produce plasma propulsion to extreme speeds. Said plasma tube with plasma from the annular ring, or from any capacitors, can be used for emergency flight in the event of failure of the plasma vortices. Flight to original destination can be maintained.

As the electric system of the aircraft is fluctuating direct current, with inductance and capacitance, there will be an alternating current component. The current appears to move in one direction, but the current will be moving in two directions. The moving alternating current magnetic field, combined with a moving diamagnetic plasma current, magnetic field, encircling said moving particles, both fields cutting the same conducting field windings at multiple points, will generate a large amount of electricity. The initial torque in starting, evidently carries over and remains manifest in one direction, but the current is moving in two directions.

Referring to FIG. 1, the encircling plasma fields of this craft will affect the steel-hulled craft, the same as electric coils around a steel cored electromagnetic. As the energetic charged particles rotate around the ferromagnetic craft, there is a concomitant increase in the magnetic intensity of the ferrochromium steel hull of the aircraft. High magnetic fields will be approached by the aircraft in this manner. These high magnetic fields will translate into elevated electric fields and electric currents.

The preferred embodiment for material for said blades is conducting tungsten cobalt zirconium material. This material tolerates high fields and high temperatures. The preferred embodiment for the field windings around said blades is tungsten wire. Said tungsten wire is a conductor and can tolerate high temperatures. On-going research has indicated that high field conditions are approached with tungsten's high magnetoresistivity. The resistance in the aircraft electric current carrying tungsten field windings, with the craft capacitance and inductance systems, form the electromagnetic portion of the craft oscillatory circuit. By connection of the rotating plasma vortices to the craft field windings in craft annular ring, the obiting plasma fields become part of the craft oscillatory circuit along with the electromagnetic radiation emitted by the inductance coil, and absorbed by the overarching plasma vortices.

Tungsten also has the highest melting point of the metals, though usually hard and brittle, it can be made pliable with hammering or other process, rendering it suitable as a wire. The array of field windings 10, 10′, FIGS. 2 and 3, will wrap the blade cores 19, 19′, FIGS. 2 and 3. When referring to the blades under said field windings, said blades are called blade cores. Tungsten cobalt zirconium is preferred embodiment for material for said bladed ring assembly. When the ferromagnetism of the magnetic field of the smaller aircraft is lost at high fields, the tungsten based electric current in the bladed ring assembly will persist, and intensify. The diamagnetic magnetic field of the plasma 34, 34′ and 34a, 34a′, receives energy from the applied mangetic field of the aircraft. The plasma field center mass 37, 37′, is shown in FIG. 1. Said center mass represents the plasma between Langmuir sheaths 36, 36a and 36′, 36a′.

After the ferromagnetism of the craft is lost at high fields, the magnetic field of the annular ring of blades assembly 2, 2′, will continue to increase to high fields. Said ring has a potential for an extended magnetic field beyond the ring magnetic field 49a, 49b, FIG. 5. The ring magnetic field is shown on both sides of aircraft in FIG. 5.

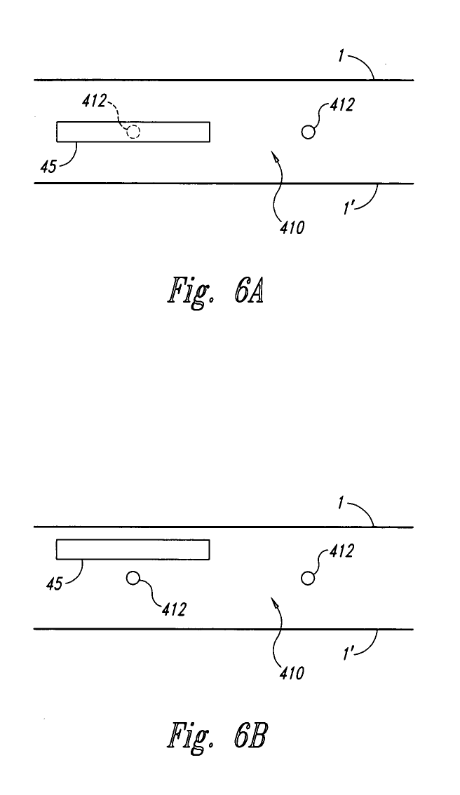

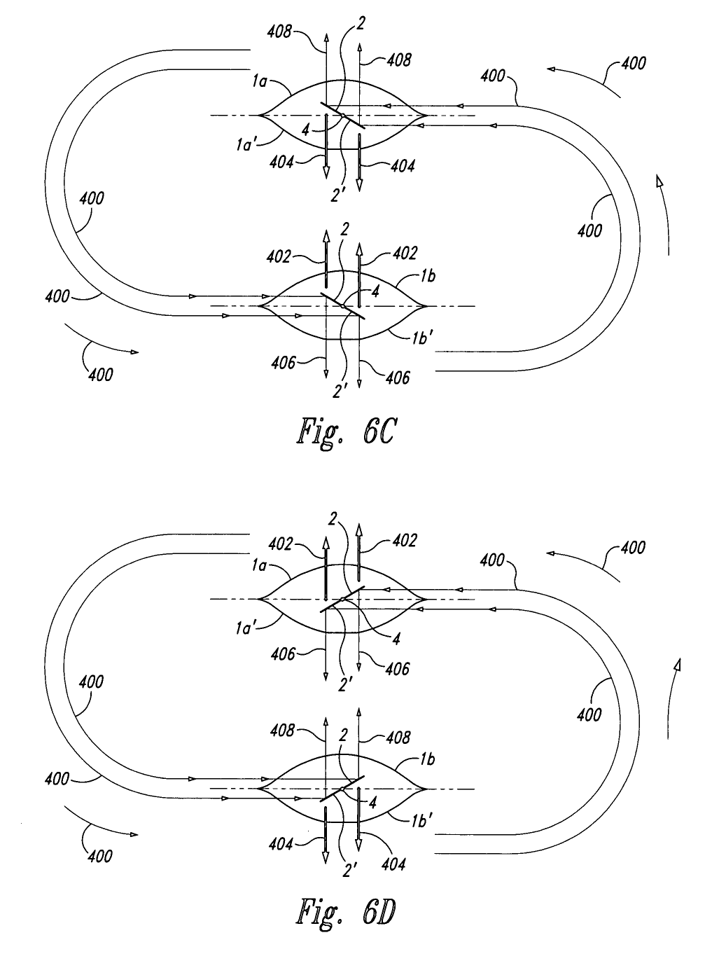

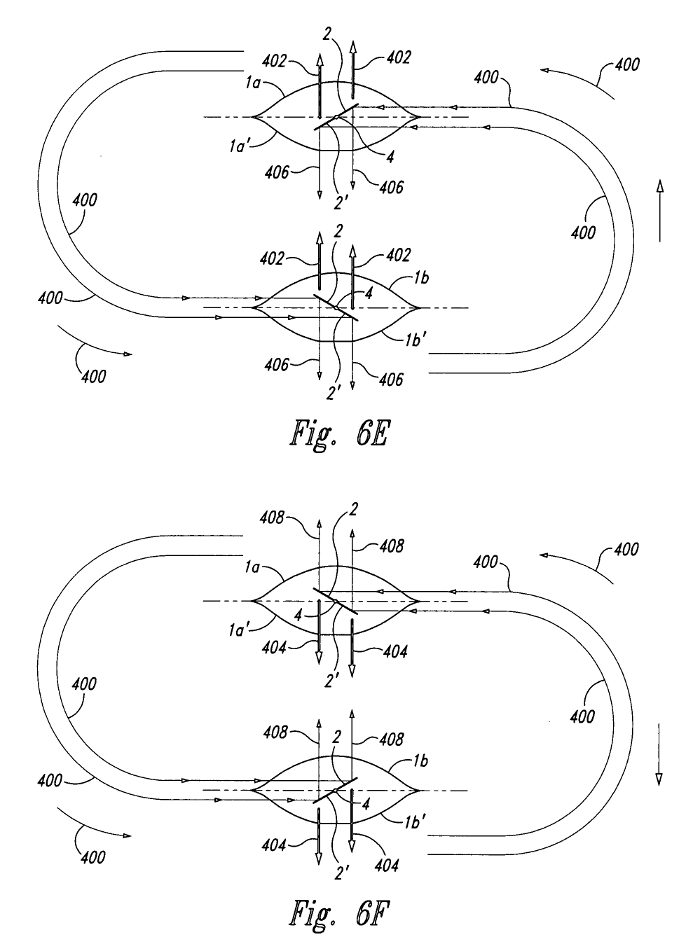

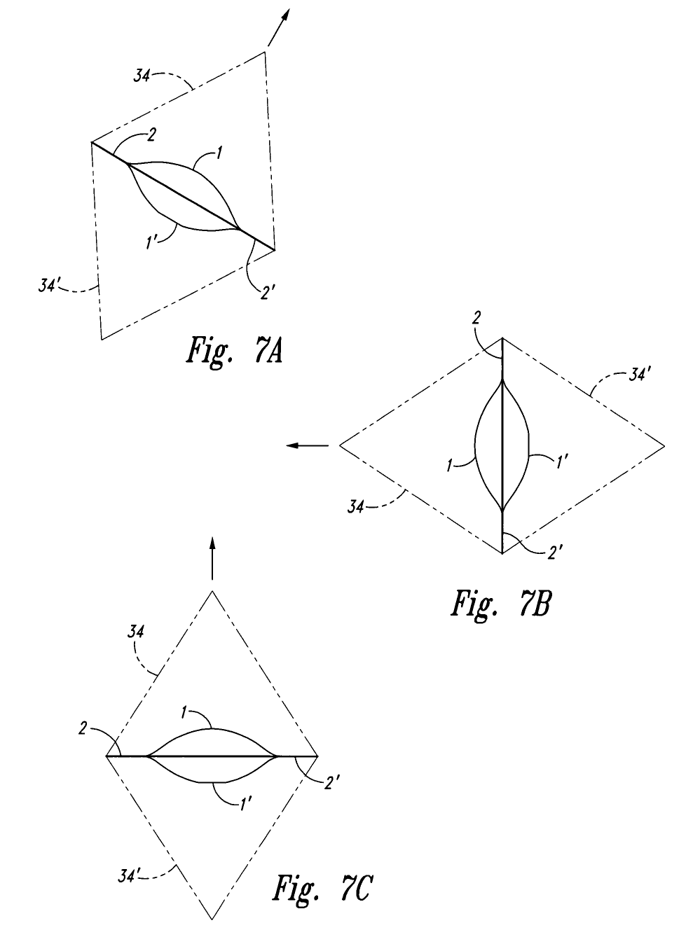

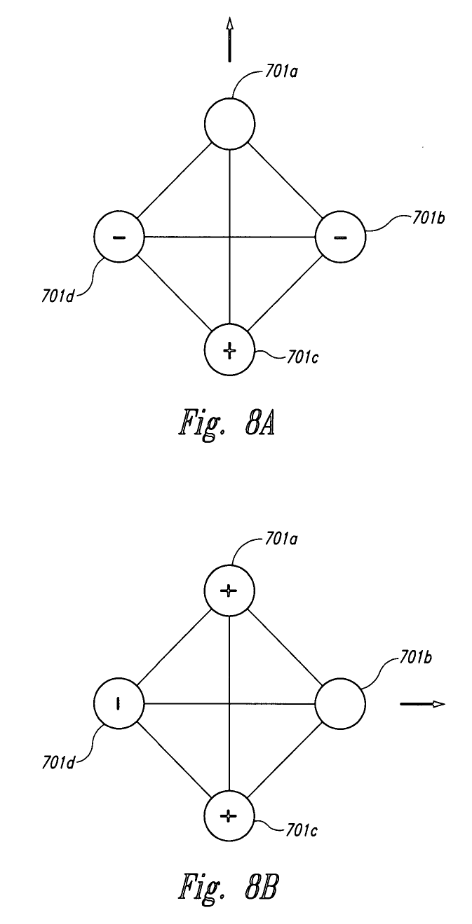

Referring to FIGS. 6C, 6D, 6E and 6F, the aircraft 1b and 1b′, is shown in a sideview showing the end of aileron 2 positioned over axel 4 in FIG. 6C. On the opposite side of aircraft 1b, 1b′, is aircraft 1a, 1a′, which is a cross section side view showing an aileron 2, on the exact opposite side to blade 2 on aircraft 1b, 1b′. The orbiting plasmas are rotating around the two halves of same aircraft. The particles impact aileron 2 on aircraft 1a, 1a′. The same path of orbiting particles 400 impact aileron 2 on aircraft 1b, 1b′, only this impact is on the opposite side. These are the two sides of same aircraft. This is a banking procedure for this single aircraft. One aileron is turned up as shown in FIG. 6C, the blade on the other side is turned up exactly the same, but the plasma, the particles are impacting opposite sides of these ailerons even though they are turned up exactly the same. The dark arrow to the right of figure in FIG. 6C, indicates direction of banking movement. Similar directional arrows are to the right of figure in FIGS. 6D, 6E, and 6F, as well.

In conventional aircraft, one aileron is turned up and on the other side, the blade is turned down. The explanation for aircraft 6C, 6D, 6E and 6F, is, the particles are moving in opposite directions on each side of the aircraft, as depicted in said figures. The ailerons are conducting, the blades possess a charge. The dominate charge of the ailerons is negative from electric current in field windings on the ailerons. The negative current attracts the large positive charges, and repels the negative charges with repulsive force. The large attraction for positive charges results in impacts on the negative charged ailerons as shown within FIGS. 6C, 6D, 6E and 6F. The equally significant repulsive force against the equally fast, if not faster, electrons, is met by a combined repulsive force between the two negative chages. Abrupt maneuvering, much faster than aerodynamic forces on a conventional aileron, are realized by electric forces on this aileron.

The opposite side of impacted aileron is not facing particle flow 400 to the same degree, effect is less.

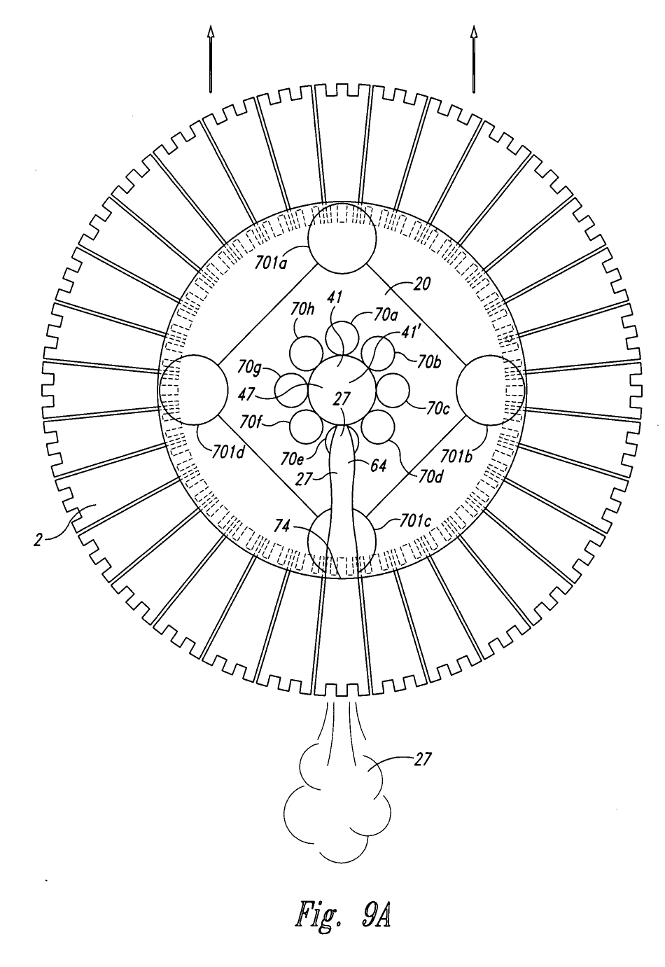

Referring to FIGS. 7A, 7B and 7C, propulsion or flight by use of rotating vortices of the plasma fields 34, 34′, FIG. 1, is shown. By utilizing ailerons for positioning the aircraft, as shown in FIG. 7A, and by increasing energy from the capacitance or inductance systems to the vortices 34, 34′, thereby increasing rotation of vortices, motional flight can commence. The plasma gun can assist in propulsion where needed.

The directional movement of said aircraft in FIGS. 7A, 7B, and 7C, is in direction as indicated by arrow.

Extreme speed is possible with this mode of flight. Increase in vortex rotation leads to a lengthening of said vortex.

Referring to FIGS. 7A, 7B and. 7C, descent mode for rotating vortex method of propulsion begins with a descent in altitude. Flight to intended landing site is similar to a helicopter maneuver for landing. Stopping directly over intended descent site, rotation of the vortices is slowed, slowing in rotation of vortices will rock the craft from side to side as craft slows. Ailerons 2, 2′, FIGS. 2 and 3, can be utilized to navigate the craft during descent.

Referring to FIGS. 8A and 8B, utilizing capacitors as electrodes, with the high fields this craft will develop, does become feasible. It is expected this will be an emergency landing option. It is expected this form of propulsion will permit the craft to move at a slow rate of speed, as an emergency propulsion option. The craft can then be slowly landed. This is a third emergency landing option behind use of plasma from the annular ring directed through an on-board plasma gun, or use of said plasma gun with standard pulsed capacitor based current and plasma from a large and a small capacitor. Aluminum material is preferred embodiment for material for capacitors, magnesium is recommended.

A vacuum exists below the vortices, and as a dielectric for the capacitors will permit a high breakdown voltage. A preferred embodiment for dielectric for the capacitors is titanium dioxide compound. Said compound can be applied to the capactors.

To date as adequate explanation of the underlying principle for capacitor propulsion or asymmetrical capacitor thrusters has not been forthcoming.

A most basic aspect of electric fields is being misinterpreted, being, a positive charge in an electric field experiences a force making it move in a direction where the potential is decreasing. This factor is being misinterpreted, and used as an incorrect, more specifically, an unfounded fact, explaining movement of electrostatic particles between said asymmetrical capacitors. First, it has not been established that electrostatic particles account for movement of said capacitors. Second, said movement of capacitors is attributed to exterior electrostatic particles. Third, this erroneous assumption, is really attributable to the fact, applicant believes what is being observed is, a positive charge in an electric field experiences a force making it move in a direction where the potential is decreasing. This phenomenon is being used as an explanation for capacitor propulsion.

Evidently, no new physical principles are involved in this form of propulsion by means of capacitors, or asymmetrical different sized, or shape, capacitors.

Due to the large capacitor potential of said aircraft, capacitor propulsion will adequately serve as an emergency propulsion system within an atmosphere. Adequate to maintain said aircraft in a stable, slow moving state, while craft is slowly landed.

Referring to FIG. 9A, said aircraft has a fluctuating direct current with a large pulsed current. Plasma 27 will be produced by ionization on the uninsulated multi-bladed annular ring assembly 2, 2′, FIGS. 2 and 3. Plasma 27, FIG. 9A, is also produced from uninsulated current on field windings 10, 10′, FIGS. 2 and 3, and also from the large and small capacitors and the electric coil throughout the central shaft. A plasma gun 64 will extend from one of the eight small capacitors 70a, 70b, 70c, 70d, 70e, 70f and 70h, surrounding the crew access tube 41, 41′, FIG. 5, to a position parallel with the midle of one of the large capacitors, and opposite to said small capacitor. Said large and small capacitors are connected by plasma moving through a plasma gun, and the electric field is at right angles to the magnetic field, as is the plasma gun, and the resulting Lorentz force will Accelerate the flow of conducting plasma through said horizontal plasma gun.

The craft will also be invisible to radar as plasma absorb all electromagnetic radiation, including the radiation they produce. An insulated trailing wire outside the plasma vortices will be required to receive or transmit signals or visual spectrum. Said trailing wire will hang below said bottom vortex; and should be uninsulated a short distance below said vortex. An antenna can be deployed above the magnetic north pole of the craft, electromagnetic radiation is polarized and visible.

Referring to FIG. 9B, when referring to said aircraft, the magnesium based, larger aircraft, are also being indicated. The two types of aircraft differ only in composition of hulls, and size. If only one type aircraft is being referred to, it will be so stated. The aircraft depicted in FIG. 9B, is the same aircraft shown in FIG. 9A, and the same plasma gun 64, is depicted in both figures. There is one difference, the plasma gun 64, in FIG. 9B, has the plasma ejection end 74, pointing inward, towards the central shaft 41′, FIG. 5, and in a position to eject plasma 27, into the central shaft 41′. Said injected plasma exiting said central shaft on the bottom of hull 1′.

Referring to FIG. 9C, plasma 27, exiting from bottom of central shaft 41′, is indicated by ejected plasma cloud 27, FIG. 9C. Direction of movement of horizontal aircraft 1, 1′, or a larger aircraft B or C, is shown by arrows on top of depicted craft. Movement is in direction opposite from direction of ejected plasma 27, as indicated by directional arrows above craft.

Plasma 27, is shown being injected into the craft central shaft 41′ at midpoint of craft. Direction of plasma is reflected downward for said plasma being injected into central shaft 41′.

Said plasma will be repelled by the negative north pole in the upper part of the inductance coil 47 as said electric driven plasma has a dominating negative charge. At the same time, the plasma will be attracted by the positive south pole.

After being ejected into the central shaft 41, 41′, at midpoint in said shaft, the plasma from the plasma gun will be ejected from the bottom of inductance coil 47, 47′, having been further accelerated by the high electromagnetic energy in said coil.

The plasma gun plasma ejection end 74, can then be oriented to provide thrust from the side of aircraft between hull 1 and hull 1′, after the craft has ascended into the air, and propelling the craft in a lateral direction sideways horizontal or at an angle to earth.

In the event the surface of the earth has a negative charge, a possible, but unlikely event, the aircraft can be inverted, upside down. This would be the normal procedure if aircraft was already operational, however, in the event, the aircraft has not yet ascended, the plasma gun may be required for vertical ascent, unless said aircraft is highly charged after storing energy from a nuclear fusion reaction. The plasma gun will direct plasma into central shaft 41′, directed downward, and with craft motional direction for upward movement from said rotating plasma vortices on top and bottom of said aircraft, the craft will rise off the earth and become airborne.

Even though the plasma gun 64, enables the craft to operate at high energy levels prior to the nuclear fusion event, said event being the ignition of the fusion spherical plasma, the aircraft is also being raised to high energy levels by the rotating plasma vortices increasing the craft ferromagnetism.

The plasma gun 74, FIG. 9C, will receive electric current, primarily a byproduct from the plasma process occuring on the uninsulated field windings around the blades in the bladed ring assembly 2, 2′, FIGS. 2 and 3.

The plasma gun is also receiving plasma from the capacitors as well as off the bladed ring assembly.

The plasma will be ejected from the bottom of central shaft 41, 41′, FIG. 5. Said bladed ring assembly will provide a large electric current within the conducting plasma moving through the plasma gun. The largest amount of plasma comes from annular ring.

The conducting plasma is accelerated by the electric current from the annular ring, and by a Lorentz force.

The conducting plasma is also accelerated by the conducting current moving within the moving plasma in the plasma gun.

The plasma will be ejected from the bottom of the craft from the bottom of the central shaft, from the inductance coil.

Due to the large electric current off the bladed ring assembly moving through the plasma, and accelerating said plasma, the plasma ejected from the bottom of the craft will enable the craft to rise, and become airborne.

With the combination of the pulsed current from the large capacitor system, the large electric current from off the annular ring, and plasma from annular ring, craft will ascend.

The aircraft plasma gun will have a powerful plasma current due to the aircraft's vast array of capacitors, and the pulsed current from the aircraft fluctuating direct current, a pulsed current from the oscillatory circuit of the aircraft. Short bursts of high voltage, electric energy, can be provided to the plasma gun. Utilizing the Lorentz force, the craft will be propelled with extreme speed. The plasma tube 64 can be moved to all sectors around perimeter of the craft or under craft.

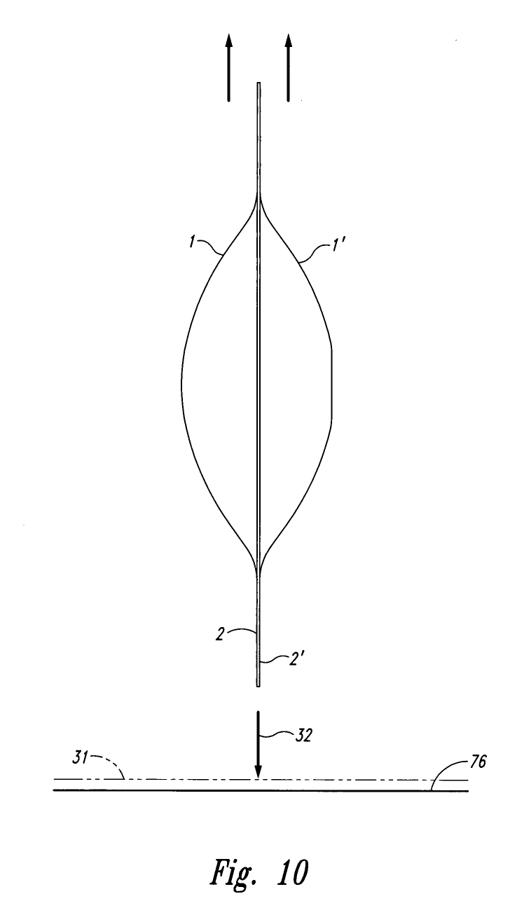

Referring to FIG. 10, the aircraft is shown in a perpendicular position relative to Earth 76. In this position the electric field 32, FIG. 10, of the craft is interacting with earth's magnetic field 31 at a ninety degree right angle, resulting in maximum repulsive force between the craft's electric field and magnetic field of the earth. The high fields of this aircraft, make this form of propulsion possible. Extreme acceleration perpendicular to the earth is possible. In another mode of propulsion, when the magnetic field of the craft is directed downward, when the craft is parallel with the earth, a high repulsive force between the positive charge on the bottom of the craft, and the positive earth, usually, is present. Also the magnetic field around the capacitor system as arrayed parallel with the earth, is also directed straight downward. As the magnetic field of the craft rises to high fields, said magnetic force contributes to the craft's rise off the earth.

The high magnetic field induced in aircraft by the rotating orbiting plasmas will also increase the electric field in bladed ring assembly 2, 2′, FIGS. 2 and 3. The chromium steel. hull 1, 1′, FIG. 1, will be magnetized like the steel core of an electromagnetic. Said orbiting particles being the electric coils. Said particles will raise the craft to high fields.

Referring to FIGS. 4 and 5, an electric system 20, FIG. 4 connects the capacitance and inductance systems and the extensive connecting electric wiring of the craft to the engineer control panel 540, FIG. 5, located behind the pilot area 113, FIG. 5, in engineer area 114. Said engineer panel will contain diagnostics for plasma and electric controls. Instruments and gauges 542 for pilot aircraft control are the same as other dynamic aerodynamic craft, and will include flight control systems 539, FIG. 5.

The aircraft 1, 1′, will be controlled by the electric system 20, FIG. 4. When energy in the capacitance electric system is depleted, energy will be obtained from the connected magnetic energy storage in the inductance system from the connected inductance coil. Deck floors 96, 96′, FIG. 5 are carbon-graphite material.

Energy produced by the rotating plasmas raising the ferromagnetic craft to high fields, will be stored within the inductance system and the applied magnetic field of the craft. The 32 sets of capacitor plates, comprise 64 individual plates. The 32 blades in the ring of blades have a weak current entrance and a strong current exit, 64 openings. The appropriate plate will be connected to an appropriate opening in a blade, 64 plates to 64 blade openings.

Referring to FIGS. 2 and 3, tungsten field windings 10, 10′, are shown wrapped around blade 2, 2′, in beaded ring assembly 2, 2′. Said field windings are wrapped around a blade core 19, 19′, comprised of tungsten cobalt zirconium material. Said blade core will be sharpened on the longitudinal edge 17, 17′, on both longitudinal sides of each blade in said bladed ring assembly 2, 2′. The sharpened edges will permit electric current from the uninsulated tungsten field windings 10, 10′, to be electrically conducted through said blade cores 19, 19′, forming a diamagnetic electric current moving through said blade cores, and a diamagnetic plasma current on top of said blade cores. Said circular electricity moves through all the blades around said aircraft. The currents move between all of the blades due to the electric wind effect, and due to the diamagnetic plasma currents normal current flow. The electric wind effect penetrates through air space 18, 18′, between longitudinal sides of said blade edges 17, 17′.

The field windings wrapped around blades 2, 2′, at blade ends 45, 45′, are wrapped longitudinally around said blades, permitting a pinch effect 55, 55′, on ions and electrons released and energized by The uninsulated field windings high voltage. The field windings are wrapped around blade cores 19, 19′, at blade notches 7a, 7a′, 7b, 7b′, 7c, 7c′, 7d and 7d′. A weak electric current 9a, 9a′ will enter the field windings at the weak current entrance, and a strong current 9b, 9b′, will exit at the strong current exit. Incipient combustion and fire suppression nozzles 30, 30′, are shown inside sharpended lip 5, 5′.

The sharpened lip on the edge of hull 1, and hull 1′, permits accumulated pooled current of opposite charge to be safely exhausted onto the bladed ring assembly, preventing a flash-over. The sharpended hull edge, also manifests the electric wind effect. Window 25a, FIG. 3, is for the pilot and co-pilot. Window divider 15, separates area of assignment for pilot and co-pilot. Window 25b is for plasma electric engineer.

The three legs comprising the landing gear 6a, 6b and 6c, are shown arrayed on the bottom of hull 1′, around soft landing surface 43, and arrayed around slag removal hole 41′. The aircraft 1, 1′, and larger versions of said aircraft with a differing hull material composition, will discharge accumulated slag through the slag removal hole 41′, and into the ocean or other suitable disposal site. Said slag is a natural by-product of plasma fusion operations, and operation of the plasma based aircraft. More exactly, the slag produced also contains airborne contaminates as well as metallic residue. A slag mass is a more exact characterization of said waste material, more correctly referred to as slag mass, but herein referred to as slag, for brevity. The slag removal hole 41′, is also used as the crew access tube 41, 41′, FIG. 5.

Operation of the plasma based aircraft has reduced the plasma surrounding aircraft to its basic constituents, mostly electrons and protons, and in the process removed the contaminant residue, slag mass, comprising C02, alumina, silicates, and other residue referred to as airborne contaminants and the causitive factors in global warming. The remaining atmosphere utilized within the plasma vortices, will be recycled back into the atmosphere purified of contaminants.

As the aircraft does not require any contaminating fuel to operate, it utilizes only the energy within the atmosphere, as plasma to operate, and in the process of operating, removes contaminants within the atmosphere. It is the ideal means whereby carbon dioxide, C02, can be removed from the atmosphere. Said aircraft is a decontamination device.

The aircraft by itself will reduce global warming effects. In conjunction with said fusion process, a process portion of this patent, it can almost totally end said warming effects.

The process portion of this patent pertaining to a nuclear fusion reaction utilizing the boron B-11 isotope ion to form a fusion spherical plasma, utilizing said aircraft 1, 1′, in said process, and further utilizing a hi-power laser or neutal beam to effect ignition of the spherical fusion plasma, can completely eliminate the source of most of the world's C02, carbon dioxide contaminants by means of clean fusion energy.

Energy from the nuclear fusion reaction, can be beamed by microwave or other means, to nearby energy power storage facilities. At the present time, the majority of the world's electricity is generated from coal and petroleum.

End of operation section of aircraft preferred embodiment.

Beginning a description of the preferred embodiment of aircraft.

Referring to FIGS. 1, 2, 3, 4 and 5, a preferred embodiment of the Multi-Functional Aircraft (MFA), also called aircraft, craft, or device is shown. The aircraft is comprised of a body hull 1, 1′, FIG. 1, comprising a top half hull 1, FIGS. 1 and 2, as well as bottom half hull 1′, FIGS. 1 and 3. A bladed ring assembly 2, 2′, FIGS. 1, 2 and 3, is mounted between the top and bottom half hulls 1 and 1′. An individual blade 2, 2′, is shown in FIG. 4, at 12 o'clock in ring system, attached to an axel 4, FIG. 4, and said axel to blade attachment ring 16, FIG. 4, to connecting portion of the blade attachment ring 16. All 32 of the blades in bladed ring assembly 2, 2′, are pivotally attached to blade attachment ring 16. The bladed ring assembly 2, 2′, is connected to said capacitors by electric system 20, FIG. 4. Said capacitors are in turn connected to electric system 20, FIG. 4.

Said electric system 20, further comprises capacitor plates 701a, a′, 701b, b′, 701c, c′, 701d, d′, and 702a, a′, 701b, b′, 701c, c′, 701d, d′, and 702a, a′, 702b, b′, 702c, c′, 702d, d′, and 703a, a′, 703b, b′, 703c, c′, 703d, d′, and 704a, a′, 704b, b′, 704c, c′, 704d, d′, and 705a, a′, 705b, b′, 705c, c′, 705d, d′, and 706a, a′, 706b, b′, 706c, c′, 706d, d′, and 707a, a′, 707b, b′, 707c, c′, 707d, d′, and 708a, a′, 708b, b′, 708c, c′, and 708d, d′, FIG. 5.

Said capacitor system in FIG. 5 is connected by electric system 20, FIG. 4, to the top and bottom of inductance coil 47, 47′, FIG. 5.

Said capacitor system in FIG. 5 is interconnected by electric wires 801a, a′, 801b, b′, 801c, c′, 801d, d′, and 802a, a′, 802b, b′, 802c, c′, 802d, d′, and 803a, a′, 803b, b′, 803c, c′, 803d, d′, and 804a, a′, 804b, b′, 804c, c′, 804d, d′, and 805a, a′, 805b, b′, 805c, c′, 805d, d′, and 806a, a′, 806b, b′, 806c, c′, 806d, d′, and 807a, a′, 807b, b′, 807d, c′, 807d, d′, and 808a, a′, 808b, b′, 808c, c′, and 808d, d′, FIG. 4.

The four quadrants of said electric wiring system 20, FIG. 4, comprise quadrants 60a, 60b, 60c, and 60d, comprising wiring between said adjacent capacitors, FIG. 4.

Said electric system 20, FIG. 4, also includes electric wires interconnecting said small capacitors 70a, 70a′, 70b, b′, 70c, c′, 70d, d′, 70e, e′, 70f, f′, 70g, g′, and 70h, h′, FIG. 5 and FIG. 9A. said small capacitors are connected in parallel.

Insulated copper wire is preferred embodiment for craft wiring system. Thick wire is preferred embodiment for inductance coil. Enamel insulation is preferred insulation for inductance coil.

Also within the electric system 20, is the electrolysis system

FIGS. 12D and 12E. The ferromagnetic cores 112a, 112b, 112c, 112c, 112d, 112e, 112f, and 112g, FIG. 12E, part of the electrolysis system FIG. 12E, will increase in magnetic intensity due to ions orbiting around said ferromagnetic cores, this feature is a principle part of the fusion process, as it permits particles exiting onto roof of said ferromagnetic craft, to coalesce into a spherical plasma.

Said capacitor system FIG. 5, is further connected by electric system 20, FIG. 4, to the top and bottom of the inductance coil 47, 47′, FIG. 5.

Referring to FIG. 1, the top most point on top vortex 34, is apex 55, on bottom vortex 34′, the bottom most point is 55′. An extra sharp edge of the hull, a hull lip 5, 5′, permits accumulated pooled current, electric charge on top and bottom hulls of craft, to be exhausted onto the annular ring surface 2, 2′, preventing flash overs of opposing charges. The set of blade notches 7a, 7b, 7c, 7d and 7a′, 7b′, 7c′ and 7d′, FIGS. 2, 3, and 4, best seen in FIG. 4, are for field windings 10, 10′, FIGS. 2, 3 and 4. The electric current enters field windings at weak current entrance 9a, FIG. 2 and exits at strong current exit 9b, FIG. 2. Said weak and strong currents are best seen in FIG. 3.

The applied magnetic field has non-moving poles, with fluctuating direct current with an alternating current component.

Said field windings 10, 10′ will wrap blade cores 19, 19′, FIGS. 2 and 3. Said blade cores will be comprised of tungsten, cobalt zirconium material. Said blades 2, 2′ also act as ailerons 2, 2′ for navigation of aircraft. Nozzles 30, 30′, FIGS. 2, 3, and 4, best seen in FIG. 4, placed between blades, are above and below blades on the hull exterior surface 1, 1′. Said nozzles are to extinguish fire or incipient combustion forming on blades due to high temperatures. Said nozzles, also, as conceived is an opening at the end of a hose by accepted definition. Openings 410, FIG. 6B, are to extract or replace blades through said opening. Landing gear 6a, 6b, and 6c, are shown in FIGS. 1 and 3. Said landing gear can be extracted into or out of area within lower deck 96′, FIG. 5, and lower deck wall 8′, FIG. 5. Shown in FIG. 3 is soft landing surface 43, not requiring deployment of said landing gear prior to landing. Said soft landing surface is indicated by circular dash lines on bottom of craft hull 1′, FIG. 3.

Referring to FIG. 5, circular magnetic field 49a and 49b, surround blade assembly ring 2. 2′. An upper deck floor 96 and a lower deck floor 96′ are shown. The top of the electric system 20, is shown on planar surface of the top of the bottom half of hull 1′. Interior walls 8, 8′, of hulls 1, 1′, are covered with an octagonal structural frame of beehive configuration with insulation and material to withstand temperatures of outer space, and the intervening thermosphere. Cabin doors are shown for access to lower and upper deck. Access to cabin door 26b to lower deck 96′, and access to upper level through cabin door 26a is from crew access tube 41, 41′, for both cabin doors. Said crew access tube is a hollow cyclinder, and also serves as a central support shaft 41, 41′, for both upper and lower hulls. The crew access tube 41, 41′, also serves as a pressure rlease tube 41, 41′, during a nuclear fusion reaction process. The crew access tube 41, 41′, also serves as a surface for inductance coil 47, 47′, and serves as a lag removal hole 41, 41′. Said central shaft also has recessed, curved hand and foot bars 57, for ascent and descent within said tube, during entrance or exit from crew hatch doors 23a and 23b, on top of top hull 1, and bottom of bottom hull 1′. Said central shaft is also utilized by said plasma gun.

Referring to FIG. 5, depicted is an electrolysis system with columns 111a, 111b, 111c, 111d, 111e, 111f, and 111g. Above said columns are connecting columns 112a, 112b, 112c, 112d, 112e, 112f and 112g. Said two enumerated sets of columns, in numerical sequence attach sequencially to barrels 142a, 142b and 142c, located behind barrel 144, best seen in FIG. 12E. Said electrolysis system will be described also within a fusion portion of this patent. Said electrolysis system is used within an atmospheric environment to produce energy from a nuclear fusion reaction without significant radiation or heat produced. In a non-atmospheric environment, the electrolysis system can produce plasma vortices from water or other liquids or ice, as a means for propulsion by vortex action with plasma vortices, or to produce an atmosphere within a larger domed environment. By rotating a number of disengaged capacitor plates beneath aircraft annular ring, with craft-located inside and at top of a domed environment, said craft can generate heat, light, and soft rain.

Referring to FIG. 5, the pilot window 25a, is comprised of glass comparable to a deep diving bathysphere glass window. Similar glass comprises rear window 25b. Said window 25a is for pilots, rear window 25b is for the plasma engineer and crew. The pilot and co-pilot share the same window. Said window will be divided by a center line 15, FIG. 1, to delineate areas of assignment for pilot and co-pilot. The applied magnetic field is formed from magnetism remaining in chromium steel hull 1, 1′, and from the magnetic poles formed by the craft inductance coil. Said hull is similar to an automobile bumper in that it will reflect the firmament, sky. When entering crew access tube 41, 41′, said crew must wear heat resistant, non-conducting suits and gloves with helmets. Extreme ionizing effect will persist after departing craft through said shaft. Higher ferrochromium steel is also a recommended material for said aircraft hulls.

Referring to FIG. 5, engineer control panel 540 is located on upper deck in engineer area 114. Said panel will contain diagnostics for plasma and controls for said plasma, and also gauges and controls for the capacitor based electric system 20, FIG. 4. Instruments and gauges 542, FIG. 5, for pilot aircraft control, and flight control systems 539, FIG. 5, will be located in pilot area 113, FIG. 5.

As said aircraft is also an aerodynamic aircraft, it will utilize the same instruments, gauges and flight control systems used by other aerodynamic aircraft, which includes modern, jet propelled aircraft. Said controls are electric based controls. The aircraft will use the capacitor based electric system, and when the capacitance system is diminishing in energy, the magnetic energy stored in the inductance system will be used.

The aircraft electric system 20, controls the amount of energy going to the field windings, thereby controlling the number of ions freed to the vortices, thereby controlling the vortices. The amount of energy to or from the vortices will be controlled by said electric system and connected magnetic inductance system.

The Larmor orbiting particle plasma field 34, 34′ and 34a, 34a′, FIG. 1, is produced by electrons and ions from the uninsulated bladed ring assembly 2, 2′, FIGS. 2 and 3. Said ions depart said assembly ring with a Lorentz force, being projected at right angles to the magnetic and electric fields of said aircraft, said fields being at right angles to each other. Said charged parrticles are then projected into perpendicular Larmor gyro orbits around said craft within the applied magnetic field of aircraft. Charged particles along the length and width of said bladed ring assembly will be emitted. Ions will also be produced en mass by collision or heat. Said formed plasma field, above and below the bladed ring assembly, will be the length and width and circumference of said bladed ring assembly. Said plasma fields will be turning to the right when viewing craft in the air from the ground looking up. Both the top vortex 34, 34a, and bottom vortex 34′, 34a′, will be turning to the right. Therefore, the motional direction for movement of the aircraft, by the right hand rule, is upward, for both the bottom and top vortex, fixed within craft magnetic field.

The orbiting particle field 34, 34′ and 34a, 34a′, FIG. 1, is covered by a Langmuir sheath 36, 36′ and 36a, 36a′, FIG. 1. A vacuum 3, FIG. 1 within center of space above hull 1, FIG. 1, forms, facilitating formation of a fusion spherical plasma. Said vacuum 3, 3′, FIG. 1, is between orbiting particle field 34a, 34a′, FIG. 1, and the hull 1, 1′, FIG. l. Said vacuum forms in this area immediately upon formation of said Larmor particle, plasma vortices. The vacuum persists. Upon formation of said vortices, the emitted electromagnetic radiation 44, 44′, FIG. 5, emitted from inductance coil 47, 47′, FIG. 5, within said vacuum, is absorbed, as said plasmas absorb all electromagnetic radiation. When this craft lands in an area with small water deposits on the earth, or elsewhere, said small ponds will freeze over, even in the summer. This is a vacuum effect. Area between the hulls is also a vacuum 3, FIG. 1, center of aircraft between the hulls 1, 1′, FIG. 1.. The carbon graphite deck floors 96, 96′, FIG. 5, have a melting temperature of over 3000 degrees Centigrade.

Referring to FIGS. 2 and 3, blade 2, 2′, comprised of the materials tungsten cobalt zircononium, is wrapped by field windings 10, 10′, said field winding wire is comprised of the material tungsten. Said blade core 19, 19′, comprised of the material tungsten cobalt zirconium, will be sharpened on the longitudinal edges on both longitudinal sides, said longitudinal edges 17, 17′ of each blade in said bladed ring assembly 2, 2′.

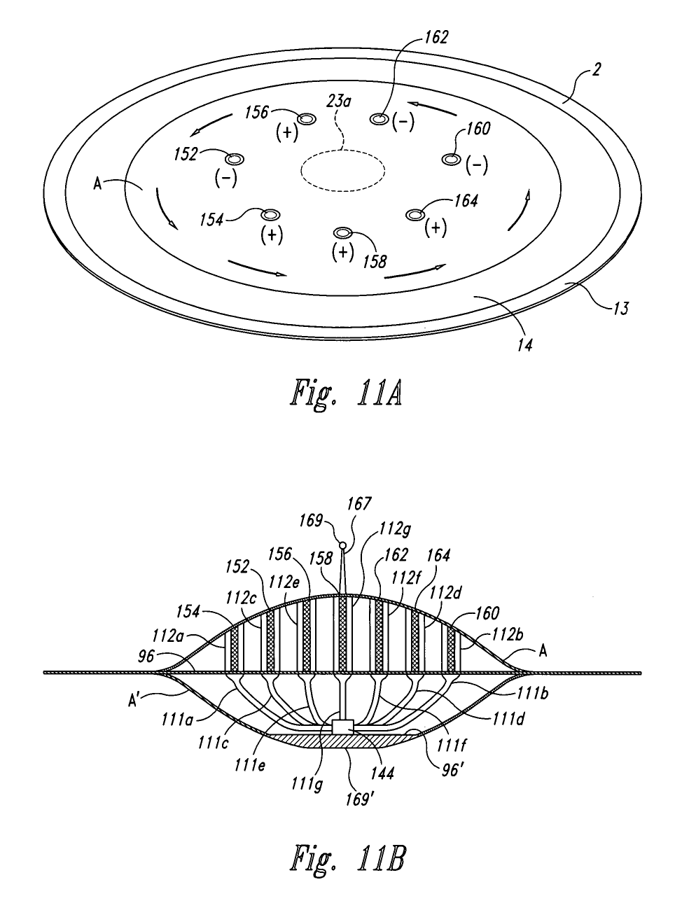

Said sharpened edges will permit an electric current from said field windings to be conducted across, through said blade cores. Said circular current 14, 14′, FIGS. 2 and 3, is conducted through said blade cores between the outer edge of blade cores 13, 13′, FIGS. 2 and 3, and the hull surfaces 1, 1′. FIGS. 2 and 3, on said blade assembly ring 2, 2′. Said ring is best seen in FIG. 11A.

An electric wind effect will permit electric current to flow between blades separated by a short air space 18, 18′, Said air space is located between said blades, longitudinally, air space 18, 18′, FIGS. 2 and 3.

Said field windings are wrapped around blades at blade end 45, 45′, FIGS. 2 and 3. The edge between said blade ends and the blade assembly ring conducting electric current conducted around said ring, is ring edge 13, 13′, FIGS. 2 and 3.

A diamagnetic plasma current is also circling on the top surface of said conducting ring 14. The diamagnetic plasma current is an extension of said plasma vortices.

A slag mass removal hole 41′, FIG. 3, permits removal of accumulated metallic residue, airborne contaminants, and, fusion reaction slag. The hole 41′, is positioned at the end of crew access tube 41, 41′, FIG. 5.

The three legs comprising the landing gear 6a, 6b and 6c, are shown arrayed around the bottom of said aircraft in FIG. 3. Also shown is a soft landing surface 43, and said slag removal hole 41′, FIG. 3.

The positioning of the two rows of longitudinally placed field windings 10, 10′, FIGS. 2 and 3, will permit a pinch effect 55, 55′, FIGS. 2 and 3, to exist between said pairs of field windings on each blade, and a pinch effect 55, 55′, also exists between adjacent field windings on blades that are adjacent. Specifically, the space between a single longitudinally placed field winding on one blade, and the longitudinally placed field winding on the next blade. The intervening space also manifests a pinch effect.

Said aircraft to include varients of said aircraft, larger or of a different material composition, also possess a decontamination potential of significance. The claimed operation of said aircraft, also manifests capability to not only ameliorate global warming, but in a larger sense, to solve global warming. If economies would utilize applicant's invention for transportation and electric energy generation, global warming might end.

Referring to FIG. 6A, a plurality of holes 412 through blade attachment ring 16, FIG. 4, to insert a plurality of axels 4, FIG. 4, is shown. Said axels are attached at the opposite end to a plurality of blades 2, FIG. 4, forming a bladed ring assembly of 32 blades, 2, FIG. 4. Said holes 412, FIG. 16A, will be insulated to insulate axel 4 from blade attachment ring 16. Said axel 4 attaches to blade end 45, FIG. 6A of blade 2 through hole 412 as shown by lead line to hole 412, FIG. 6A, located behind the center of blade end 45, FIG. 6A. Also shown is opening 410, FIG. 6A, to extract worn or burnt blades through area between the hulls 1, 1′, FIG. 1. Said area comprising opening 410, FIGS. 4 and 6A.

Referring to FIG. 6B, blade end 45 FIGS. 2 and 6B, is shown in opening 410, FIG. 6B, between hulls 1, 1′, FIG. 1, being removed above hole 412, FIG. 6B, as a smoking or worn blade to be replaced.

Referring to FIG. 6C, a single aircraft is shown. A side view of half Of craft 1b, 1b′ and a cross section of the remaining half of the craft 1a, 1a′, are shown. The front half of blade is slanted downward, the rear half of blade is turned up. Moving charged particles 400 in orbits around said aircraft are shown. Particles 400 impact the bottom of blade on axel 4 of aircraft 1b, 1b′, and are reflected downward 406 on entire bottom portion of blade on axel 4. The bottom impact on aileron 2 by particles 400, produces an opposite and equal reaction and movement in opposite direction. The blade and aircraft, half of aircraft 1b, 1b′, are moved upward. On the opposite side of aircraft 1a, 1a′, orbiting particles are now moving in the opposite direction relative to aircraft 1b, 1b′. The aileron 2, 2′, FIG. 6C on aircraft 1a, 1a′, is in the same position as the blade 2, 2′, FIGS. 2 and 3, on the opposite side of aircraft 1b, 1b′. The moving particles 400 are now impacting the top of the blade and are reflected upward 408, simultaneously, the blade and aircraft are moved downward 404. This opposing movement on each side is a banking maneuver. It resembles conventional jet aircraft, but is an entirely new method of navigation. Though, the exact same controls and systems used on said jet aircraft, can be utilized on aircraft 1, 1′. The blade at axel 4 will move upward into a more energetic particle orbit, and the other half of blade will move downward into a more energetic particle orbit. The results will be instantaneous banking of the aircraft.

Referring to FIG. 6D, a single aircraft is shown. A split, front side view of aircraft is shown, and a cross section, split, rear side view of craft is shown at the top. The moving charged particles 400 are impacting the top of blade between axel 4. Particles are reflected upward 408, opposite opposing force is downward 404. The other side of same aircraft, a cross sectional view, shows the moving charged particles 400 impacting blades between axel 4 on the bottom. The particles are delected downward 406, a reactive force upward 402, then banks aircraft upward on the left, assuming aircraft is traveling to the right.

Referring to FIG. 6E, the bottom craft shown is one side of an aircraft. An opposite cross sectional view of the side of the top aircraft is also shown. Both views, top and bottom, are of one aircraft. Charged particles 400 are impacting blade at axel 4 striking blade bottom, deflecting downward 406. The same particle orbit impacts the top aircraft aileron at axel 4 deflecting downward 406 with a reactive force upward 402. The aircraft will ascend in altitude. This operation is similar to the increase or decrease in altitude by the use of elevators on the tail of conventional jet aircraft. Said elevators are located in the tail section.

Referring to FIG. 6F, a moving charged particle field represented by arrowed lines is impacting aircraft 1b, 1b′, on the top of the aileron on axel 4, deflecting, particles upward 408, with an equal and opposite reactive force downward 404. The orbiting charged particles impact aircraft 1a, 1a′ on the top surface of aileron on axel 4, deflecting downward 408 with an equal and opposite force downward on aileron and aircraft, 404. The aircraft will descend in altitude.

Referring to FIG. 7A, a field of Larmor gyro orbiting particles, orbiting around craft hull 1, 1′, is shown. The aircraft in FIG. 7A has been positioned in direction of the arrow by using ailerons 2, 2′, FIGS. 2 and 3. The rotating vortices will move aircraft in the direction indicated by arrow. Increased energy to rotating vortices 34, 34a and 34′, 34a′, will increase length of vortex 34′, 34a′, and increase the rotating rate of both the top and bottom vortex. Said increased energy will also increase the speed of aircraft.

Referring to FIG. 7B, an aircraft with hull 1, 1′ has been positioned horizontal relative to the earth, in direction of travel indicated by arrow. The aircraft has been positioned in a horizontal position by ailerons 2, prior to acceleration. The rotating vortices will move aircraft in direction indicated by arrow. Increased energy to rotating vortices 34, 34a, and 34′, 34a′, will increase length of vortices and also increase the rotation of both vortices, and will increase the speed of aircraft.

Referring to FIG. 7C, an aircraft is shown having been positioned in a vertical position by ailerons 2, 2′, FIGS. 2 and 3. Direction of travel has been indicated by arrow. The aircraft is perpendicular to earth. The aircraft has been positioned by ailerons 2, 2′, prior to acceleration. The rotating vortices 34, 34a, and 34′, 34a′, FIG. 1, will move the aircraft at increasing speed as rotating of vortices increases. The vortices will also increase in length as rotation increases.

Referring to FIGS. 7A, 7B, and 7C, descent mode for rotating vortex method of propulsion begins with a descent in altitude. Flight to intended landing site is similar to helicopter maneuver for descent. Stopping directly over intended landing site, rotation is slowed. The slowing in rotation of vortices will rock the craft as it slows. Descent is in vertical mode, FIG. 7C. Ailerons can be used in descent to level aircraft.

Referring to FIG. 8A, motional movement of an aircraft by using an array of capacitors is shown. In this instance, the capacitors are performing as electrodes, specifically, said large capacitors 701a, 701b, 701c, and 701d, within FIG. 8A. Said large capacitors 701a, 701b, 701c, and 701d, within FIG. 8A. Said array could contain more electrodes, in correct arrangements. In FIG. 8A, the single capacitor 701c is indicated as being positively charged, and capacitor 701d and 701b, negatively charged. Capacitor 701a does not have a charge. Direction of movement will be as indicated by arrow, in this example, in the direction of more highly charged electrode 701d and 701b.

Referring to FIG. 8B, the capacitor electrodes 701a and 701c are indicated as more highly charged than the oppositely charged capacitor electrode 701d.

Electrode 701b does not have a charge. Movement will be in the direction of more highly charged electrodes as indicated by arrow. The fluctuating direct current utilized by the capacitance system, is a positive factor applying potentials.

The capacitors are of a circular configuration.

Referring to FIGS. 9A, 9B, and 9C, a plasma gun 64, for plasma propulsion is shown in FIG. 9A. The plasma gun is also called plasma tube, exit 74 for plasma that has been accelerated is also shown. Eight small capacitors 70a, 70b, 70c, 70d, 70e, 70f, 70g and 70h surround the central shaft 41, 41′. Said eight small capacitors are connected in parallel by said electric system 20, FIG. 4. One of the small capacitors, and a large capacitor opposite said small capacitor, on the same side of central shaft 41, 41′, will be connected by an intervening plasma gun 64. Plasma can exit said plasma gun from ejection end 74, as shown in FIG. 9A by said large capacitor. Plasma 27 will be ejected toward the rear of craft. Said craft will be propelled in the opposite direction, in direction as indicated by arrows. Or, plasma 27 can be ejected from ejection end 74, into said central shaft 41′, FIG. 9B. Said plasma will exit from the bottom of craft. Craft will be propelled upward away from earth in direction as indicated in FIG. 9C. Due to the large and powerful array of capacitors, and due to a powerful pulsed current in the aircraft, and primarily. due to the large amount of electric energy driven plasma-off the annular ring of blades, plasma will be ejected from inductance coil.

Referring to FIG. 9D, the aircraft used as a space craft, is shown. When said craft enters a gravity free area in space, hulls will be closed after the blade system has been retracted into craft. The blades will be retracted to form two levels of retracted blades, each level containing 16 blades, for a total of 32 blades, but only the top level of 16 blades is evident in FIG. 9D. Both levels of blades can be connected to tubes inserted in axel holes forming full diameter holes between hulls, or only one level, the top level, will be used in preferred embodiment. Said tubes connected from the small capacitors to the large capacitors, and then said tubes will be projected through said axels holes, and eject particles for particles propulsion in space. Said particles will be accelerated by alternating current in the alternating current component of the fluctuating direct current of the craft. Usually, alternating current consumes a disproportionate amount of energy for effect desired, but in this craft, it is part of the existing electric system. Axels 4, are shown in FIG. 4.

In space the small capacitors 70a, a′, 70b, b′, 70c, c′, 70d, d′, 70e, e′, 70f, f′, 70g, g′ and 70h, h′, will be connected to large capacitors 701a, a′, 701b, b′, 701c, c′, 701d, d′, and 702a, a′, 702b, b′, 702c, c′, and 702d, d′, by connecting tubes for particle propulsion 80a, 80b, 80c, 80d, 80e, 80f, 80g, 80h, 80i, 80j, 80k, 80l, 80m, 80n, 80o, and 80p, FIG. 9D. the connecting tubes will insert through axel holes arrayed under 16 of the 32 blades in the bladded ring assembly 2, 2′, FIGS. 2 and 3. The unused axel holes will remain plugged, in preferred embodiment. Axel holes 412, are shown in FIG. 6A.

The tubes inserted in the axel holes will project particles into space for propulsion, said particles accelerated by an alternating current, repulsive charge to accelerate particles.

An accelerated particle stream 83, FIG. 9D, is shown on the opposite side of craft from the arrows indicating direction of travel for said aircraft, said direction of travel being a reaction from said accelerated particle stream in the opposite direction, at accelerated particle exit hole 413m, FIG. 9D.

In space the accelerated particle exit holes 413a, 413b, 413c, 413d, 413e, 413f, 413g, 413h, 413i, 413j, 413k, 413l, 413m, 413n, 413o, and 413p, will be connected to connecting tubes for particle propulsion 80a, 80b, 80c, 80d, 80e, 80f, 80g, 80h, 80i, 80j, 80k, 80l, 80m, 80n, 80o, and 80p, FIG. 9D

Said accelerated particle stream 83, FIG. 9D, is shown exiting from exit hole 413m in FIG. 9D.

Said accelerated particle stream 83, can be instantly shifted to any of the accelerated particle exit holes, also called exit holes, around the circumference of said aircraft.

By means of said array of exit holes, the aircraft is enabled to instantaneously change direction of travel to avoid an instrument sensed on-coming object in space. The available large number of possible directions of travel by means of said exit holes, is required when it is realized, unlike on earth, objects can arrive from under the craft, as well, 180 degrees in any direction from under the craft, as well as 180 degrees in any direction above the craft. Said plasma gun can be utilized for vertical control of space craft maneuvers.

Each of said blades arrayed around interior of craft, 16 blades, can be used as a particle propulsion system in space, instantaneously, to avoid oncoming objects in space, or for navigation in space. An accelerated particle stream 83, FIG. 9D, is shown.

The preferred method for storing said plasma for particle propulsion, is by storage in the vast array of capacitors. Said plasma stored as metal ions in said plates will be used for particle propulsion in space. Circling plates under craft charges plates.

Said aircraft can attain high speeds, near the speed of light, over time, months to a year. For shorter trips, to Mars or the asteroid belt, a trip may only take two or three months. Half of the time accelerating, and the other one half, decelerating.

Referring to FIG. 9E, the aircraft used as a submersible craft is shown. Said submersible craft is depicted with blades extended. The blades 2, FIG. 2, used as propellers 666, FIG. 9E, are shown. Said blades 2, are rotatable 360 degrees when used as ailerons 2, FIG. 6C, and are also rotatable 360 degrees when used as propellers 666, and will be rotated at propeller end 667. Conducting propellers interact with conducting water with the magnetic and electric fields of the craft at right angles to each other, ions from he uninsulated blades used as propellers will be projected at right angles to both fields with a Lorentz force directed against conducting water, thereby propelling said submersible craft, said propellers also propelling craft. A plasma gun 64 with exit end 74, is shown for propulsion also.

Energy for said propellers is stored in inductance system and in the capacitor plates in said array of capacitors. Said propellers will revolve slowly, in a synchronized manner, whereby craft will be propelled in a straight path, and at the same time slowly revolve.

Said rotating propellers will be used for propulsion, and also to navigate said submersible craft.

For rapid egress from an area, an onboard plasma gun 64, can be used for propulsion. Said plasma gun can be moved to any location around the circumference of the submersible craft. Said plasma gun receives energy from plasma stored in said array of capacitors as metal ions. Plasma exit end 74, is shown.

Said plasma gun can also be used to navigate the submersible craft.

Upon impacting water from airborne flight, the craft hulls will be gravity closed. Upon leaving water, hulls will be gravity opened.

Axels 4, FIG. 4, will be closed positioned between precut half diameter holes on rims of each hull. Half of said full diameter axel hole will be on one hull, and the opposite half on the other hull.

The axels will be between the two half diameter holes on closing said hulls. Hulls will close together upon the axels.

Referring to FIG. 9F, a boring device is shown. The aircraft can be used as a boring device by attaching a drill 87, to the aircraft by positioning said drill through the craft central shaft 41, 41′, FIGS. 5, and attaching the bottom of the drill to drill base plate 88b, said base plate attached to bottom of bottom hull 1′ craft. A drill brace plate 88a, with a center hole to insert the drill through, is attached to the top of the top hull 1, of the aircraft. In a stationary mode, the aircraft can be used as a boring device. The aircraft has a approximate 25 degree rotation, and then an approximate one second halt, and then another 25 degree rotation, and an approximate one second halt. The halt is most likely due to the oscillatory,. pulsed, fluctuating direct current of the aircraft. The rotation most likely explanation, is the following. The ferromagnetic craft is pulled into rotating by the magnetic field of the diamagnetic plasma current operating within said aircraft pulsed current. Said natural rotation of the craft can be used to rotate said drill attached to the aircraft.

Referring to FIG. 9G, the aircraft used as a lifting device is shown. The aircraft can be used as a lifting device by inserting titanium cross bars 888a and 888b, and attaching cables to two or more ends of the four ends of said titanium cross bars. Said attaching cables, cables 889a and 889b, are shown attaching by lifting hook 891, to load 892 in FIG. 9G. Said titanium cross bars can be inserted between said hulls, attached and sitting on top of the lower hull rim, curving around central shaft 41, 41′.

Referring to FIG. 10, the aircraft is shown positioned perpendicular with the earth 76. The electric field 32 of the aircraft, is in the direction of the arrow toward the earth. The electric field 32 will interact with the earth's magnetic field 31, with a strong repulsive force. The high fields of the aircraft will make possible rapid ascent with this form of propulsion.

With the aircraft applied magnetic field within an oscillatory circuit, with a stronger electric field than magnetic field, and with said plasma field and diamagnetic plasma current moving in a counterclockwise direction when viewed from the ground looking up, said fields will pull the positive particles, primarily protons, in the direction of the electron current flow to the right.

End of description of the preferred embodiment for aircraft.

Beginning of the operation of the process portion of the patent.

The operation of the process portion of the patent pertains to operation of a nuclear fusion reaction-process utilizing said aircraft alone, or with other, similar aircraft.

The following is a description of the preferred embodiment for operation of the process portion of said nuclear fusion reaction.

The fusion energy portion of this patent is a process, more specifically, it is a method for producing electricity from a nuclear fusion reaction without significant radiation produced, or cooling required to be provided.

The fuels used for this nuclear fusion reaction will be the boron B-11 isotope ion and regular hydrogen.

Said fusion process is referred to as a radiation free nuclear fusion reaction. Negligible radiation and heat are produced.

Negligible radiation and heat will be produced in this B-11 isotope ion nuclear fusion reaction.

Said fuels are found in borax found in nature as tincal. The state of California has approximately 200 million tons of tincal. Turkey has approximately 500 million tons of tincal. Said B-11 ion is also found in boron from bromine in seawater.

Electrode 160 and 164 are reversed in FIG. 11A as opposed to FIG. 11B. Both Figures are correct, the electrode pairs will stay connected, but be physically crossed, to obtain necessary repulsive attractive charges for fusion reaction. Pairs from said barrel.

A brine solution will be used in vaporization process involving seawater. A boric acid solution will be used in vaporization process using borax to obtain the B-11 isotope ion for said nuclear fusion reaction. The fusion reaction is accomplished primarily by utilizing a tightening induced Larmor particle field induced by raising a ball electrode within the applied field, said applied magnetic field, already possessing an established Larmor gyro-orbiting particle field. By means of inducing said smaller Larmor orbiting particle field within an induced magnetic field, within an existing magnetic field, an expanded applied magnetic field will exist, or the induced magnetic field will exist within the applied magnetic field. In either case, the effect is approximately the same.

A vacuum 3, 3′, FIG. 1, exists under all of the rotating plasma vortices of said aircraft 1, 1′, also called device A, A′, FIG. 11B.

The induced Larmor orbiting particle field 184, FIG. 12A, forms around a forming fusion spherical plasma 170, FIG. 12A, on the roof of aircraft 1, 1′, FIG. 1, also called device A, A′, FIG. 12A.

By means of an on-board electrolysis system FIGS. 12D and 12E, a boron B-11 isotope fusion spherical plasma can be formed on roof of the smaller ferromagnetic aircraft. The glass ball electrode 169, FIG. 11B, can also function as an induced magnetics north pole.

Upon raising a pyramidal cone 167, FIG. 11B, with said glass ball electrode on top, an induced magnetic field is formed below the ball electrode, and an induced Larmor orbiting particle field. Over time the induced Larmor particle field will tighten around said fusion spherical plasma, increasing pressure and temperature.

The induced Larmor gyro orbiting particle field, over time, as it receives increased energy from the existing magnetic fields, said induced Larmor field will tighten around said spherical plasma, as the speed of the orbiting particles increases over time, the orbits will increasingly narrow, and tighten around the spherical plasma. The ferromagnetic aircraft 1, 1′, FIG. 1, in utility portion of this patent, will increase in energy over time, as the rotating particle fields impart increased magnatizm to the ferromagnetic aircraft over time. Said energy translates into increased energy in the applied magnetic field, and the induced magnetic field, over time. The induced magnetic field receives its energy from the same source as the applied magnetic field. The induced orbiting plasma fields receive energy from the induced magnetic field.

Two larger, similar aircraft to said smaller aircraft 1, 1′, FIG. 1, are referred to as aircraft B, B′, and C, C′, in FIG. 12A, and said smaller aircraft in process portion of patent, is referred to as Device A, A′, FIG. 12A. Aircraft 1, 1′, is Device A, A′.

Arrayed perpendicular to a horizontal Device A, A′, Device B and Device C, will position their spherical plasmas, 174, and 178, FIG. 12A, on the side of fusion spherical plasma 170, FIG. 12A. Increased pressure will be applied to fusion plasma 170. In the process of expanding the applied magnetic field, there exists the fact that the applied electric field was also expanded, raised up. Now the center of the electric current cuts through said fusion plasma, to a degree, providing increased temperature. The two larger aircraft are providing increased pressure. The electron volt temperature is nearing ignition temperature. If ignition cannot be obtained spontaneously, land-based hi-power laser and, or, neutral beam can be used.

Referring to FIGS. 11A, 11B, 12A, 12D and 12E, depicted are elements of the fusion process utilizing apparatus for an electrolysis system. Said apparatus includes barrel shaped containers for boron B-11 isotope ions 144, FIG. 11B. Said barrel 144 of B-11 isotope ions is connected to tubular column 111g.

Laminated glass is preferred embodiment for tubular columns. The B-11 isotope ion tubular column 111g, FIG. 11B, is connected at one end to ferromagnetic cored column within a larger B-11 ion tubular column 112g, FIG. 11B. Said ferromagnetic column is connected at the other end to exit electrode 158, FIG. 11B, said electrode also called roof electrode.

Said B-11 isotope ion will exit roof electrode 158, FIG. 11A, at insulated electrode 158, having been placed into mini-Larmor gyro orbits around said ferromagnetic cored column prior to exiting electrode.

Said B-11 ion will exit roof electrode with charge indicated by positive sign located under said roof electrode designation. Direction of movement is indicated by arrows, FIG. 11A.

Said particle has been energized while rotating around said ferromagnetic column, and this has not diminished the magnetism of said ferromagnetic column, it has increased the magnetism of the cored column, as well.

Barrel 144, FIGS. 11B and 12D, alone contains the fusion fuel boron B-11 isotope ion. Said isotope ion can be vaporized out of source prior to electrolysis procedure, or the B-11 isotope ion can be vaporized out of source on board said aircraft. The source being a brine solution from seawater, containing bromine from boron in the seawater, or a boric acid solution from borax from tincal from deposits in California or other parts of the world.

The remaining fuel source for the fusion reaction will be electrolyzed out of water or seawater, most likely on board said aircraft. The remaining fuel source will be constituents for the H-1 atom, protons and electrons, and with the B-11 isotope ion, forming the fuel elements for the fusion process.

Said electrolysis system is best seen in FIG. 12E. The referenced containment barrels for B-11 fuels for the fusion process, are best seen in FIG. 12D, barrel 142a, 142b, 142c and 144. Though, said barrels are also shown in FIG. 12E.

The maximum current to decompose said fuel solutions completely, to resulting particles desired, being protons, electrons, and the B-11 isotope ion, will be accomplished by two separate procedures, evaporation and electrolysis, can be accomplished on board the aircraft. Water for electrolysis is stored in barrel shaped containers. Platinum electrode is preferred material for electrolysis. Said electrolysis apparatus has what appears to be two arms, columns, on each side of individual barrels, except for said B-11 isotope ion column, which has an individual arm, column, projecting straight upward. The three barrels 142a, 142b and 142c, FIG. 12D, contain water, H2O. Said barrels of water will be electrolyzed by electrodes in FIG. 12D. The B-11 isotope ion will be vaporized out of source, a boron source. Either boric acid from borax from tincal, or boron from a seawater source, a brine, bromine from seawater. Oppositely charged particles will exit each barrel, positive on one side, negative on opposite side. Though, not on the same side on all barrels. The B-11 isotope ion column will extend staight upward.

Sources for boron B-11 isotope ion includes seawater or borax. Borax is a compound found in nature as tincal. Tincal is available in millions of tons, over 200 million in California, a half billion in Turkey. It is also found in Tibet and many other countries of the world to include Russia. For the radiation free and direct conversion to electricity fusion reaction, boron B-11 isotope ion is required, uniquely. The hydrogen atom, H-1, is also required (H+ plus e−). The H-1 atom can be obtained from the electrolysis of water. Said tubular columns are also called tubes.

No fusion reaction is radiation free, the B-11 fusion reaction is conventionally referred to as a radiation free reaction. There is no significant radiation produced, or cooling required, using the fuels boron B-11 isotope and regular hydrogen. Energetic charged particles will be produced and stored within vortices.

Barrel 142a, FIGS. 11B, 12D and 12E, contain absolution of H2O, water, for electrolysis by electrode. Said barrel is connected on one side to tubular column 111a. Said column is connected at the other end to ferromagnetic cored column within a column 112a. Said ferromagnetic column 112a is connected at the other end to exit electrode 154, FIGS. 11A and 11B. The positive sign under said electrode 154, indicates exiting electrode is a positively charged particlee, in this instance, a positive proton. Said proton is moving in direction indicated by arrows in FIG. 11A. On the other side of said barrel 142a, said barrel is connected to tubular column 111b. Said column 111b is connected at the other end to ferromagnetic cored column within column 112b. Said ferromagnetic column is connected at the other end to exit electrode 160, FIGS. 11A and 11B. The negative sign, under said electrode 160, indicates exiting particle is a negative electron and moving in the direction indicated by arrows, FIG. 11A.

Barrel 142b containing water for electrolysis by electrode 188, FIG. 12D, is best seen in FIGS. 12D and 12E. In FIG. 12E, on one side of barrel 142b, said barrel is connected to tubular column 111c. Said column is connected at the other end to ferromagnetic cored column 112c. Said ferromagnetic column is connected at the other end to exit electrode 152, FIGS. 11A and 11B. The negative sign under said electrode 152, indicates exiting particle is a negative particle, in this case an electron e−, and moving in direction indaicated by arrows, FIG. 11A. Bar-142b, containing water, is shown in FIGS. 12D and 12E, on the other side of barrel 142b, said barrel is connected to tubular column 111d. Said column is connected at the other end of column 111d to ferromagnetic cored column within a larger column 112d. Said ferromagnetic cored column is connected at the other end to exit electrode 164, FIGS. 11A and 11B. The positive sign indicates said exiting ion is a positive particle, a proton, and moving in direction indicated by arrow in FIG. 11A.

Barrel 142c, containing water for electrolysis by electrode 188, is shown in FIGS. 12D and 12E. On one side of barrel 142c, said barrel is connected to tubular column 111e. Said column 111e, is connected at the other end to ferromagnetic cored column within a larger column 112e. Said ferromagnetic cored column is connected at the other end to exit electrode 156, FIGS. 11A and 11B. The positive sign under siad electrode 156, FIG. 11A, indicates said exiting ion is a positive particle, a proton, and moving in the direction as indicated by arrows, FIG. 11A. Said barrel 142c, containing water, is shown in FIGS. 12D and 12E. On the other side of barrel 142c, said barrel is connected to tubular column 111f. Said column 111f is connected at the other end to ferromagnetic cored column 112f. Said ferromagnetic column is connected at the other end to exit electrode 162, FIGS. 11A and 11B. The negative sign, under said electrode 162, FIG. 11A, indicates said exiting particle is a negative particle, an electron, and moving in the direction as indicated by arrows, FIG. 11A.

Said electrodes on the roof of aircraft, FIG. 11A, are arrayed alternating from an electrode aperature charged to exit a proton, to an electrode charged to exit an electron at the next aperture. After exiting electrode, said oppositely charged particles will attract and form H-1 atoms, a fusion fuel. The remaining charged particles, B-11 iosotope ions, being positively charged will form a fuel constituent.

Rotational direction of particles on roof of aircraft, FIG. 11A, is in direction indicated by arrows. Said particles are in mini-Larmor orbits, said minature, smaller orbits, are due to the charged particles being contained within said tubular columns, and constrained to orbit around the ferromagnetic columns contained in the center of some columns, as indicated. The resultant orbits around the ferromagnetic columns are referred to as mini-Larmor orbits, a contraction of the word, minature. Said particles in said mini-Larmor orbits, upon exiting onto roof of aircraft, FIG. 11A, will initially begin forming funnel shaped spirals, and will be drawn into the forming spherical plasma 170, FIG. 12A, upper diagram.

The coordinated positioning and functioning of the three or more separate aircraft described in the field of invention, or a single aircraft, and also described in the preferred embodiment for said aircraft, are proposed methods for arriving at a nuclear fusion reaction, and in-toto are the preferred embodiments for the number of aircraft required for the fusion process. The energy from one fusion reaction, can be absorbed by a multitude of aircraft, or even, one aircraft, within said aircraft rotating plasma vortices, on one aircraft, or a multitude of aircraft.

The various aircraft used, have similar operating systems. The aircraft vary in size and material composition. The preferred embodiment for device A, A′, FIGS. 12, 13 and 14, also known as aircraft 1, 1′, FIG. 1, is ferromagnetic chromium steel. The preferred embodiment for material for said larger aircraft, Device B and C, in FIGS. 12A, 13, 14 and 15, is magnesium aluminum material, a diamagnetic substance. The hulls of the larger craft will be magnesium aluminum material, the internal structure will be extruded magnesium aluminum. Aluminum has negligible magnetism. Both metals have low melting temperatures. Aluminum is a very good conductor of electricity, and can tolerate high electric temperatures as a result. Magnesium, next to titanium, is one of the strongest and lightest materials for aircraft. The ring assembly preferred embodiment, will be the same material for the large aircraft, as for the smaller ferromagnetic craft, tungsten, cobalt zirconium material.

As the applicant understands the law, only a method of building the invention, has to be proposed, or stated. It is not required for inventor to explain why it operates as it does, if it operates as inventor states. This invention will operate as stated. It will rise off the earth, and can be accelerated in a desired direction of travel. The craft may rise solely from the vortex action of the revolving plasma vortices. More than likely, the aircraft in the invention, rises from a combination of the large array of capacitors, arrayed in parallel, providing an initial lifting force in combination with the plasma vortices. The strong magnetic force and electric force being factors. The presence, as stated of an abundance of plasma, and the presence of a plasma gun within craft, and an extensive array of capacitors in the aircraft, would suggest a combined propulsion system. The fluctuating direct current provides a strong pulsed current for the plasma gun. The vast array of capacitors arrayed in parallel, provides a strong magnetic field through the inductance coil in starting. The positive magnetic pole near, or in contact with the earth, provides a strong repulsive force against the earth. Upon rising of aircraft by these means, the ailerons can point the aircraft in the desired direction of travel, and the plasma gun can propel the aircraft in said direction.

After absorption of charged particles from said fusion reaction, by said plasma vortices, at that time, the vortices will propel the aircraft as the primary means propulsion. Prior to said fusion reaction, the aircraft will produce from available energy in the ambient air, the plasma required to initially power said aircraft. The remnant energy within the capacitance and inductance systems will produce plasma on the annular ring. The large and small capacitors will produce at the same time, plasma for the plasma gun. Thee plasma vortices will increase in energy.

The larger, magnesium aluminum hulled aircraft, bladed ring assemblies, by making contact, touching the hull of said highly magnetized Device A, will become equally, highly magnetized with said smaller aircraft, with no loss of magnetism to said smaller crafts after the fusion reaction.

The bladed ring assemblies 2, 2′, FIGS. 2 and 3, of Device B and Device C, comprised of tungsten cobalt zirconium material will be equally magnetized with bladed ring assembly of Device A. The plasma field of the aircraft, obtain energy from the applied magnetic fields. The bladed ring assemblies of the aircraft, comprised of tungsten, cobalt zirconium material, will raise the aircraft to high fields.

The top hull of the ferromagnetic hulled small craft, Device A, is required as the platform for the nuclear fusion-process. The low melting point of magnesium and aluminum, preclude their use as the base for the fusion reaction. The two billion degrees required for the fusion reaction will produce neglible heat, only electron volt temperatures are involved.

Spherical plasma can be formed on the roof of magnesium hulled craft for operating energy, or to apply pressure from opposite sides toward the central fusion spherical plasma on the roof of the ferromagnetic hulled smaller craft. The non-fusion spherical plasmas are a potential source of operating energy for the aircraft, and can be mined for electricity by insertion of conducting rods, they are a potential energy source. They may persist for an indeterminate period of time, or the electrolysis system may produce, and tap electrons off onto electrodes for electricity.

A cone shaped pyramidal column 167, FIG. 11B, is located centered on roof of the smaller aircraft prior to beginning the fusion process. A glass ball electrode 169, FIG. 11B, preferred electrode embodiment for pyramidal cone, is situated on top of the pyramidal shaped column, 167. The ball electrode is slotted and air cooled. Raising the pyramidal cone with the ball electrode on top will induce an induced magnetic field on the roof of said smaller aircraft. An induced field within a larger applied magnetic field. By positioning two similar in operation, but larger in size aircraft on each side of the horizontal smaller aircraft A, A′, FIG. 12A, and perpendicular to the smaller aircraft, the fusion process can proceed. The positioning of the aircraft is required to obtain the pressure and temperature required for ignition of spherical plasma 170, FIG. 11B.

The larger aircraft on left side of horizontal aircraft A, A′, FIG. 12A, is perpendicular aircraft B, B′, FIG. 12A. The larager craft on the right side of horizontal aircraft A, A′, is perpendicualr aircraft C, C′, FIG. 12A. The larger aircraft will have spherical plasmas on the roofs of said aircraft. Said spherical plasmas are non B-11 ion spherical plasmas. They will not contain the boron B-11 isotope ion. Spherical plasma 174, FIG. 12A, is present on the roof of aircraft B, B′. Spherical plasma 178, FIG. 12A, is on the roof of aircraft C, C′. The fusion spherical plasma 170, FIG. 12A, is on the roof of aircraft A, A′. Spherical plasma 170 contains the fusion fuel boron B-11 isotope ion. Regular hydrogen atom, H-1, is contained within the fusion spherical plasma.

By positioning the large aircraft B, B′, and large aircraft C, C′, FIG. 12A, upper diagram, perpendicular to smaller horizontal aircraft A, A′, the two larger aircraft have thereby placed their spherical plasmas on top of the roof of the smaller aircraft A, A′. Spherical plasmas 178 and 174 now abut the fusion spherical plasma 170 from opposite sides, FIG. 12A, upper diagram. The fusion spherical plasma 170 is also within the tightening, smaller induced Larmor gyro orbiting particle field 182, FIG. 12A. There also exists an induced electric current 186, FIG. 12A. Said electric current contributes to temperatures required for ignition of fusion spherical plasma, and can be assumed to be receiving energy from emitted electromagnetic radiation from ball electrode 169, FIG. 11B.

The electromagnetic radiation 44, 44′, FIG. 5, emanates from the inductance coil 47, 47′, FIG. 5, part of the aircraft oscillatory circuit. The pyramidal cone shaped column 167, FIG. 11B, is placed over circular opening remaining after removal of hatch cover 23a, FIG. 5. The ball electrode 169, FIG. 12A, is placed on top of said pyramidal cone.

The bottom rotating plasma vortex 34′ of aircraft B. B′, FIG. 12A, and the bottom rotating plasma vortex 34′ of aircraft C, C′, FIG. 12A, by increasing their rotational rate are applying pressure from both sides to fusion spherical plasma 170, FIG. 12A, on the horizontal roof of device A. The-rotational direction of plasma 174, FIG. 12B, is perpendicualr to rotational direction of fusion spherical plasma 170, FIG. 12B, and is in the opposite direction to rotational direction of spherical plasma 178, FIG. 12B, of aircraft C. These opposing rotational directions added to the pressure from the rotating vortices squeezing the spherical plasma 174 and 178 into fusion spherical plasma 170, comprise part of the increased pressure and temperature.

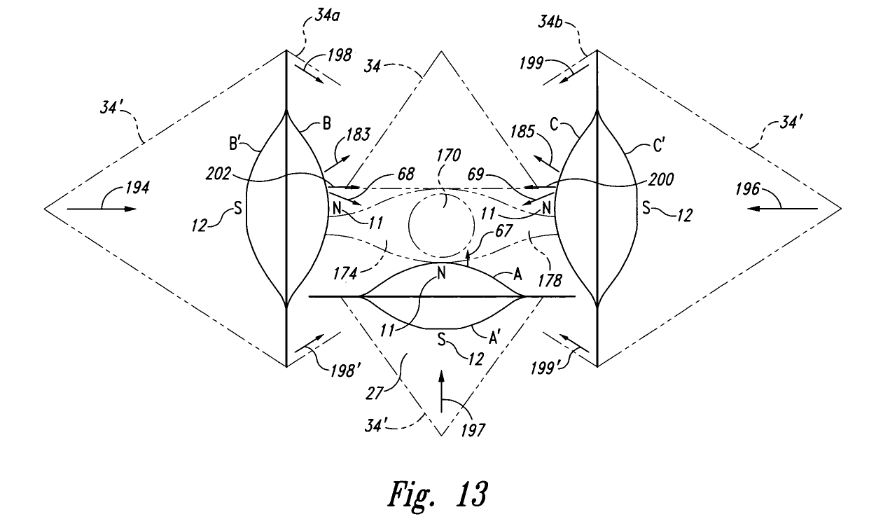

The tightening induced Larmor orbiting particle field 182, FIG. 12A has enveloped the spherical plasma 170, FIG. 12A, upper diagram. The induced electric current 186, FIG. 12A, and adding the considerable number of orbiting charged particles within the induced Larmor field, and by adding gyro orbiting particles within said spherical plasmas 174, 178 and 170, FIG. 13, conditions are nearing ignition temperature. And, with a final addition being, said Larmor field 182, side view, and 184, top view, FIGS. 12A and 12C, charged particles being squeezed into said fusion spherical plasma 170.

The rotating spherical plasmas 174 and 178, FIG. 12B, have also been squeezed into an amorphous mass around said fusion spherical plasma 170, best seen in FIG. 13. At the same time, magnetic fields 49a and 49b, FIG. 5, are now concentrating the three separate aircraft magnetic fluxes, all intersecting, with a resultant increase in thermal temperature. Heat is still being added from multiple sources. The rotating bottom vortices of device C, 34′, FIG. 13, and device B, 34′, FIG. 13, are still increasing pressure. There are extent, other pressure and heat sources. The bottom vortex 34′, of aircraft A, is pushing against repulsive magnetic forces 202, 67 and 69 from opposing north poles 202 and 206, FIG. 13, of the three aircraft.

The temperature and pressure for ignition is being approached. At the moment of ignition of fusion spherical plasma 170, there will be an appearance of flames, through it is primarily photon energy 203, rather than heat. It will appear like a flaming cylinder due to the two large aircraft B and C, being perpendicular, and the smaller aircraft, aircraft A, being horizontal, and the smaller aircraft, aircraft A, having instantaneously departed after ignition. The two large craft may appear to move even closer around the fusion spherical plasma, appearing as a single perpendicular flaming cylinder.

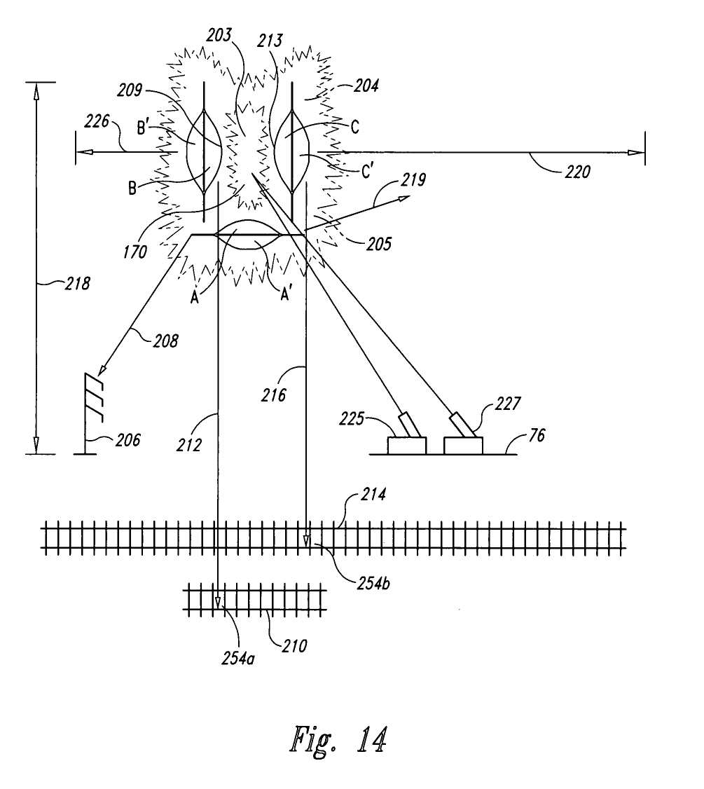

At the moment of ignition of fusion spherical plasma 170, there may be appearance of flames, through it is primarily photon energy. The three aircraft are grounded. Device A is grounded to a high power tension line. The two larger aircraft are grounded each to individual railroad tracks running in opposite directions. Device A is grounded by cable 208, FIG. 14, device B is grounded by cable 212, to railroad track 210, FIG. 14, device C is grounded by cable 216, to railroad track 214, FIG. 14. If said fusion spherical plasma does not spontaneously ignite from applied pressure and temperature, ignition can be accomplished with land based laser 227, FIG. 14, or the more potent neutral beam 225, FIG. 14.

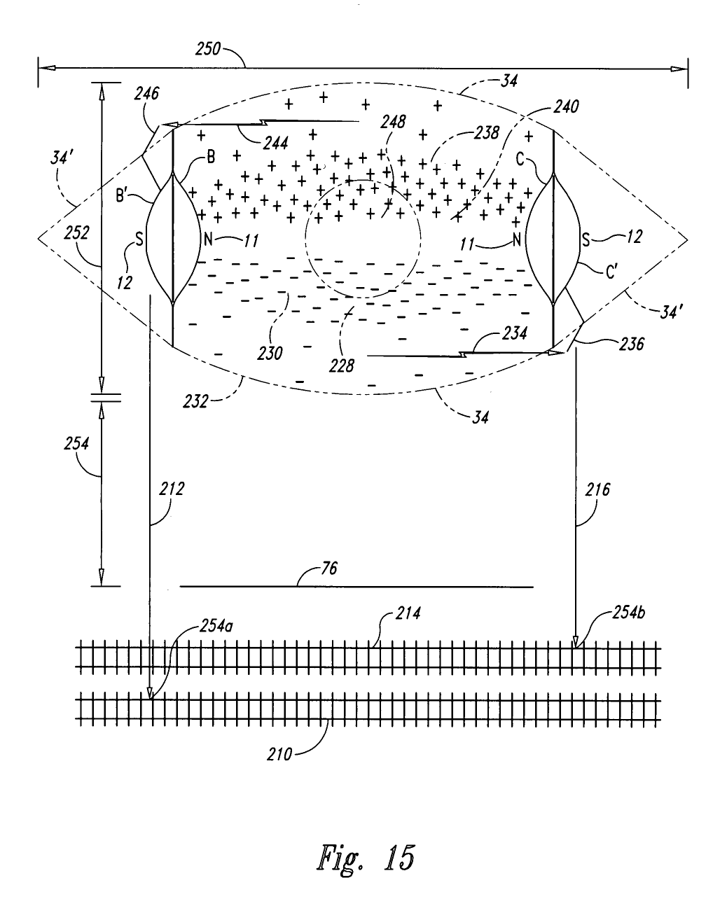

The end phase is shown in FIG. 15. The aircraft, device C will be blown and move itself to the right approximately 120 feet, device B will be blown and move itself to the left 30 feet, aircraft A will have been blown, or will have moved itself 100 feet to the west of a north facing device B and a south facing device C, approximately behind the midsection of a large plasma cloud of moving charged particles. Said plasma would ordinarily be opaque, and not visible, unless ignition occurs prior to daybreak, or at dusk.

The particles created in the nuclear fusion reaction are within a moderately dark plasma cloud at daybreak, to be visible, and are positioned between the two large aircraft. A seeming failed attempt at organizing in the center 248, FIG. 15, of the plasma cloud, leads to a collapse of the plasma formation. What ensues is similar to an atmospheric phenomenon when a storm cloud collapses and lightning is produced. The two large aircraft, device B and device C, serve as collecting-rods, in effect. Two large bolts of energetic charged particles, similar to bolts of lightning are produced. One bolt, approximately two feet in width and green in color goes to one craft, device B. Another bolt, normal lightning bolt color goes to the other craft, device C. It can be assumed the green bolt is positive charged particles, and the normal lightning colored bolt, is negative in charge. Or, the green bolt is comprised of electrostatic particles and the other bolt is energetic charged particles, predominately negative in charge. Extended rods from each aircraft will collect the bolts. The energy can be stored within craft magnetic fields within the rotating plasma vortices, stored in an on-board superconducting ring, or transmitted to a power distribution center by microwave. Energy from the bolts can be grounded.

If an on-board superconducting ring is utilized, energy to reduce temperatures to permit superconductivity will not be a factor.

End of the operation of the process portion of this patent.

Beginning of description of the preferred embodiment for the process portion of this patent as it relates to a nuclear fusion reaction process or method for producing electricity from a nuclear fusion reaction without significant radiation produced or cooling required, using the fusion fuels B-11 isotop ion and regular hydrogen atom, H-1, with nearly 100 percent efficiency.

The 11 in B-11 isotope is the neutrons, and, as all boron has five protons, the correct designation for this isotope would be ¹¹boron. Conventionally, it is called B-11 isotope, or B-11. The hydrogen atom is one proton and one electron. It is referred to as H or H-1. The ion H+, a proton, is also the hydrogen atom, H-1, without an electron. The terms B-11, H-1, and H+ will be utilized.

Referring to FIG. 11A, a top perspective view of the top roof surface of aircraft device A, is shown. insulated exit electrode apertures are shown. Electrode 156 is designated as positive by positive sign below said electrode. Electrode 156 is in reality negatively charged, the exiting particle is designated as positive by the charge sign by electrode 156. In the instant case, the particle exiting electrode 156 is a positive proton, a positive sign is shown in figure. Moving counterclockwise, for the next electrode 152, a negative electron exits. The next electrode, electrode 154, a positive proton exits. The next electrode 158, a B-11 isotope ion exits, and a positive, plus sign is indicated, and shown. The next electrode 164, a positive proton exits. The next electrode 160, a negative electron exits. The next electrode 162, a negative electron exits. Positive B-11 isotope ion 158 will repel positive proton 164 and positive proton 154., Positive proton 164 will be attracted to negative electron 160 which is repelled by negative electron 162. Negative electron 162 will be attracted to proton 156, and negative electron 152 is attracted to proton 154, which is repelled by B-11 isotope ion 158, and the B-11 isotope ion alone, is unpaired.

When the applied magnetic field expands upward due to the induced magnetic field, the applied electric current may expand upward at the same time, more definitively, will expand upwards at the same time. At that time, the induced electric field will contain a strong induced electric current, contributing to temperatures required for ignition.

Referring to FIG. 11B, a cross section side view of device A is shown. A barrel shaped container of prepared B-11 isotope ion 144 is depicted in FIG. 11B. Said barrel shaped container is attached at one end to B-11 isotope ion tubular column 111g, and at the other end of column 111g, said column is attached to a ferromagnetic cored column within a larger tubular column 112g. Preferred embodiment for the bottom tubular column 111g, is laminated, translucent shock and fracture resistant glass. For upper ferromagnetic column 112g, preferred embodiment for glass, is the same fracture and shock resistant, translucent laminated glass. Said column 112g, is connected at the higher end to exit electrode 158. The barrel 144, contains isotope ion solution said solution is a seawater brine, or boric acid, or other B-11 isotope containing solution. Said electrolysis system is best seen in FIGS. 12D and 12E.

Referring to FIG. 12A, upper portion of diagram, shown is a side view of the small aircraft, device A, positioned horizontal within the diagram. On the left side, device A, is large aircraft, device B, positioned perpendicular to device A. On the right side of device A, is large aircraft, device C, positioned perpendicular to device A. Shown on all three devices are north and south pole signs, N and S. Fusion spherical plasma 170 is shown positioned on top of device A. Non-fusion spherical plasma 174 is shown on the roof of device B. Non-fusion spherical plasma 178 is shown on the roof of device C. On each side of fusion spherical plasma 170, is depicted induced Larmor gyro orbiting plasma particle field 182. Said induced orbiting plasma field, the induced particle field, is increasingly applying tightening pressure to the fusion spherical plasma 170.

Centered within the fusion spherical plasma 170 is a raised pyramidal column 167. Said column is positioned on top of roof of small aircraft, device A. Ball electrode 169 is positioned on top of said pyramidal cone. The ball electrode is comprised of heat resistant glass with slotted apertures. The pyramidal cone is an extension of the underlying electric coil, also called induction coil 47, 47′, FIG. 5.

Raising the pyramidal cone, induced a magnetic field. Within said induced magnetic field is induced Larmor gyro orbiting plasma particle field 182, FIG. 12A, upper diagram. Also present is an induced electric current 186, FIG. 12A, upper diagram. Said induced electric current, within the induced electric field, possesses a concentration of energetic charged particles at the midpoint of fusion spherical plasma 170, FIG. 12A, upper diagram.

The non-fusion spherical plasmas are shown on each side of fusion spherical plasma 170. Said non-fusion spherical plasma 174, FIG. 12A applies pressure from the left side to center fusion spherical plasma 170. The non-fusion spherical plasma 178 applies pressure from the right side to fusion spherical plasma 170, the center spherical plasma. Plasma vortex 34′, bottom vortex of device B, and also plasma vortex 34′, bottom vortex of device C, are applying rotational propulsion pressure toward center fusion spherical plasma 170, from both sides of plasma 170.

Referring to FIG. 12A, lower diagram. Said lower diagram in FIG. 12A, is identical to FIG. 11B. Said lower diagram is positioned below upper diagram, FIG. 12A, to provide a frame of reference to identifty the central, horizontal figure, device A, within upper diagram, FIG. 12A, by means of the common pyramidal cone 167. Said reference point, the pyramidal cone, is the sole reason for said lower diagram being present in FIG. 12A. Said abstract upper diagram in FIG. 12A, is able to be comprehended as an aircraft, only by means of this common point of reference.

Referring to FIGS. 12A and 12B, in FIG. 12B the rotational direction of spherical plasmas 174, 170 and 178, are shown. Viewing the three spherical plasmas from the center plasma 170, the left spherical plasma 174, is rotating in the opposite direction to spherical plasma 178 and rotating perpendicular to fusion spherical plasma 170. The three spherial plasmas are rotating in different directions. Said varying rotational directions are contributing factor toward the increasing temperature required for ignition. Frictional heat is caused by the varying rotational directions of the three touching spherical plasmas. More specifically, the two non-fusion spherical plasmas, in contact with the central fusion spherical plasma. Also, upon absorption of the three plasmas by amalgamation, the interior rotating particles will be, initially, rotating in different directions resultant collisions will increase temperature required for ignition.

Additionally, spherical plasma 174 and 178 are being pressed into the center fusion spherical plasma 170, from both sides, by the propulsive force of the bottom rotating plasma vortices of device B and device C, represented by arrows 196 and 194, FIG. 13.

Referring to FIG. 12C, a side view of said induced Larmor orbiting particle field 182, is shown in FIG. 12C. The fusion spherical plasma 170, FIG. 12A, upper diagram, is completely encircled by the tightening induced particle field 182, at this stage. Said Larmor orbiting particle field 182, FIG. 12C, will have pressured itself into fusion spherical plasma 170, as the adjacent non-fusion spherical plasmas 174 and 178, FIG. 12B, are pressured into the fusion spherical plasma 170, as depicted in FIG. 12A, upper diagram, at start of process, and in FIG. 13, at end of process.

Referring to FIG. 12D, shown is a top view of barrels of water 142a, 142b, and 142c, also shown is a barrel shaped container of solution for B-11 isotope ion evaporation process in barrel 144, FIG. 12D. Shown within containers for electrolysis and evaporation process, are electrodes 188a, 188b, 188c, and 188d, FIG. 12D. Shown in the middle of said array of barrel shaped containers, is central shaft 41′, FIG. 12D and FIG. 5. The bottom deck, octagonal shaped interior wall structure 8′, FIG. 12D, is best seen in FIG. 5. The shape is octogonal pieces in a general beehive configuration, the bottom half of a beehive. The top half of said beehive configured interior, would be the upper one half of aircraft, the upper half of a beehive.

Said shape formed from octogonal pieces, was found by Buckminster Fuller from patterns found in nature, specifically, a beehive, and is the strongest structural frame shape known.

Referring to FIG. 12E, said electrolysis system, FIGS. 12D and 12E, is shown. Depicted in FIG. 12E, is a view of said containers 142a, 142b, 142c, and 144. Said containers attached to indicated columns in FIG. 12E, provides a complete view of said electrolysis system for said large and small aircraft. Said electrolysis system includes electrode system FIG. 12E, ferromagnetic cored columns within larger tubular columns, small columns, ferromagnetic cored columns within larger tubular columns, small columns, and electrode apertures 152, 154, 156, 158, 160, 162, and 164. Vaporization nozzles 940, 941, and 942, are depicted below barrel 144, FIG. 12E, for exhaust gases from vaporization process.

Said column 111g is attached at the other end to a ferromagnetic cored column within a larger tubular column 112g. Preferred embodiment for said column is translucent laminated glass. Said glass is fracture and shock resistant, in preferred embodiment. Said column 112g is connected at the higher end to exit electrode 158, FIG. 11A. The remaining barrels depicted in FIG. 12E utilize water, H2O, as fuel for electrolysis. Barrel 144, alone, utilizes boron B-11 isotope ion, previously vaporized out of source, or on-board aircraft vaporized out of source, the preferred embodiment. Said source being seawater or borax from tincal. Other sources are available as well. Barrel shaped container is preferred embodiment for barrels. Electrode 188d is used with barrel 144, FIG. 12E.

The bottom of column 111a, FIG. 12E, is connected to barrel 142 for electrolysis by electrode 188a, FIG. 12D. The other end of column 111a, is connected to ferromagnetic cored column within a larger tubular column 112a. Said column 112a is connected at the other end to exit electrode 154, The particle emanating from electrode 154 is a positive particle, a proton, FIG. 11A. Tubular column 111b is connected to said barrel 142a, FIG. 12E, on the other side of said barrel. Tubular column 111b is connected at the other end to ferromagnetic cored column, within a larger tubular column 112b. Said ferromagnetic cored column 112b, is connected at the other end to exit electrode 160, FIG. 11A. The particle emanating from electrode aperture 160 is a negataive paricle, an electron. Said column utilizes electrolysis electrode 188a, FIG. 12E.

The bottom of tubular column 111c, FIG. 12E, is connected to barrel 142b for electrolysis by electrode 188b, FIG. 12E. The other end of said column 111c is connected to ferromagnetic cored column, within a larger tubular column 112c. Said ferromagnetic cored column 112c is connected at a higher end to exit electrode 152, FIG. 11A. The particle emanating from said electrode opening, is a negative particle, an electron. On the other side of said barrel 142b, column 111d is connected to said barrel. The other end of said column 111d is connected to ferromagnetic cored column, within a larger tubular column 112d. Said ferromagnetic column is connected at a higher end to exit electrode 164, FIG. 11A. The particle emanatilng from said electrode is a positive particle a positive proton. Column 111d is connected to barrel 142b for electrolysis by electrode 188b, FIG. 12D.

The bottom of column 111e is connected to barrel 142c, FIG. 12E, for electrolysis by electrode 188c, FIG. 12D. The other end of said column is connected to ferromagnetic cored column, within a larger tubular column 112e. Said ferromagnetic column 112e, is connected at a higher end to exit electrode 156, FIG. 11A. The particle emanating from electrode 156 is a positive particle, a positive proton. On the other side of said barrel 142c, FIG. 12E, tubular column 111f is connected to said barrel 142c. The other end of said column 111f is connected to ferromagnetic cored column with a larger tubular column 112f. Said ferromagnetic cored column, within a larger tubular column 112f. Said ferromagnetic cored column 112f, is connected at the other end to exit electrode 162, FIG. 11A. The particle emanating from said electrode 162 is a negative particle, an electron.

Referring to FIG. 13, a side view of device A, device B and device C, is shown. Aircraft B, also called device B, is positioned perpendicualr to horizontal device A, and is located to the left of device A. Device C is perpendicualr to device A, and is located on the right of device A. Device A is horizontal to earth. The fusion spherical plasma 170 on top of device A, is now surrounded by an amorphous mass consisting of spherical plasma 174 and 178. The rotational energy of device B, bottom vortex 34′, is directed toward spherical plasma 170 as indicated by arrow 194. The rotational energy of device C bottom vortex 34′, is directed at spherical plasma 170 as indicated by arrow 196. The rotational energy and pressure of device A bottom vortex 34′, is directed at spherical plasma 170, the fusion plasma, by arrow 197, and is also directed against opposing magnetic north pole 68 of device B, and repulsive north pole 69 of device C, by the repulsive north pole force 67 of device A.

Remnant organizing rotational force directed toward the fusion spherical plasma 170 from device B top vortex 34, is represented by arrow 198, and from device C top vortex 34, represented by arrow 199, and from device B, top vortex 34, represented by arrow 198′, and from device C top vortex 34, represented by arrow 199′. Plasma propulsion 27, can be used to augment lesser rotational force of device A vortex 34′, as compared to device B and device C. Repulsive magnetic north pole force 202 from top of device B is directed as indicated by arrow 183. Repulsive magnetic north pole force 200 from device C is directed as indicated by arrow 185.

The most notable event in on-going fusion process is the absorption of induced Larmor gyro orbiting particle field 182 into fusion spherical plasma 170. The orbiting particle plasma field 182 is composed of rotating highly energetic particles increasing in energy to the speed of light. This energy has now been added to the equally energetic rotating particles within the fusion spherical plasma 170. The orbiting particle plasma field 182 is composed of rotating highly energetic particles. This energy has now been added to the equally energetic rotating particles within the fusion spherical plasma 170.

Incrementally, the process is approaching a two billion degree temperature needed for ignition, utilizing the fusion fuels boron B-11 isotope ion and regular hydrogen. Depicted in FIG. 13 is the absorption of induced electric current 186, FIG. 12A, into the fusion spherical plasma 170. Within a short period of time, the amorphous mass encircling fusion spherical plasma 170, shown in FIG. 13, will also be compressed into said spherical plasma. The amorphous mass, including spherical plasma 174 and the other non-fusion spherical plasma 178, and induced Larmor orbiting particle field 182, FIG. 12A, upper diagram, contains considerable energy. The aircraft are accompanied by a circular magnetic field around the bladed ring assembly of each device. The intersecting magnetic rings of each device will concentrate their magnetic flux with a resultant increase in temperature, and increase in temperature of the fusion spherical plasma.

Referring to FIG. 14, at moment of ignition 303, FIG. 14, there will be an appearance of flames 204, FIG. 14, around the fusion spherical plasma 170, though it is primarily photon radiation, and relatively harmless, and possessing negligible heat. Photon radiation appears, at times, almost identical to normal flames. A large quantity of energetic charged particles are being created by the fusion reaction. The ferromagnetic horizontal device, device A, FIG. 12A, will ground itself to hi-tension power line 206 by cable 208, FIG. 14. The large perpendicular device, device B, with an opposing north pole 209 facing north pole 213 of device C, will ground itself to railroad track 210 by cable 212. Large perpendicular device, device C, will ground itself to railroad track 214 by cable 216. Cable attachment systems can be remotely attached, and disengaged electronically, or by physical means, such as grappling hooks which automatically open when gravity rleased, or close when pulling up against gravity. The three devices, device A, device B and device C, are approximately 110 feet above the earth 76, at reference number 218, FIG. 14. At the moment of ignition of said fusion plasma, the smaller aircraft, device A, will be moved, as well as move itself, 100 feet in the direction indicated by arrow 218, to behind the developing plasma cloud 230, FIG. 15. Prior to ignition of fusion spherical plasma, the three aircraft will be close together, almost contiguous. The large perpendicular aircraft, device C will be blown and move itself 120 feet to the right as indicated, by arrow 220. The perpendicular aircraft, device B, on the left, will be blown and move itself 30 feet to the left as represented by arrow 226.

If necessary, ignition can be accomplished with high power laser 227, or the more potent neutral beam 225. Preferred embodiment for the number of aircraft utilized with said laser or neutral beam, is a single ferromagnetic aircraft, though three aircraft, to include said two large aircraft, and the small aircraft, is also recommended. Any number aircraft can participate within the ignition process, any reasonable number.

Referring to FIG. 15, the end phase of nuclear fusion reaction is shown. Negative ions and particles 228, FIG. 15, attracted to positive charged earth 76, collect on the bottom of plasma cloud 230. After the plasma cloud breaks down in a failed attempt to organize spherically 248, in the center of plasma cloud 230, as indicated by said weakly organizing sphere 248, in the center of plasma cloud 230, the energetic charged particles slow in a failed attempt to organize into a spherical plasma. The plasma collapses due to insufficient energy to maintain its organizing effort.

The plasma cloud formative energy comes from the magnetic fields of device B and device C and from the fusion reaction energy. In this case, the energetic particles created by said fusion reaction have been stored in magnetic plasma fields 34, 34a, and 34′ 34a′. Negative particles 228, FIG. 15, attracted to positive charged earth 76, collect on the bottom of plasma cloud 230. On the top of plasma cloud 230, FIG. 15, positive particles and electrostatic particles 238, collect, having been repelled by assumably positive charged earth 76. A Langmuir sheath 232, envelopes the entire plasma.

There is a space 240, FIG. 15, between negative and positive charges. The positive charges being repelled by positively charged earth, as a rule, and the negative charges being equally attracted by both the earth and positive charges above. The approximate width of the cloud is 150 feet, as indicated by arrow 250, FIG. 15. It is is still a plasma cloud, composed of positive and negative charges, electrostatic particles and moving charged partricles, but still enveloped by said-Langmuir sheath 232, FIG. 15. After breakdown of organizing effort by plasma 248, a bolt of green electricity, like lightning, as represented by pointed arrow 244 will strike extended rod 246, said rod extending out from of top of aircraft, device B. An equally wide, approximately one and one-half foot wide, bolt of normal colored electricity 234, will strike extended rod 236, extending out from device C. Said electric bolts, electricity, can be stored within craft plasma fields 34, 34′ and 34a, 34a′, or, if plasma vortices are already filled to capacity, said bolts can be grounded to earth, or the excess can be grounded.

It is assured the ferromagnetic craft will have the potential to store energy after ferromagnetism is lost. The magnesium aluminum hulled large craft will have almost unlimited potential to store said created energy.

Said fusion produced energy can also be stored within an on-board superconducting ring, or microwaved to a land based superconducting ring, as energy for cooling to obtain required superconducting temperature for materials used, will not be a factor.

The height of said plasma formation, plasma cloud, is indicated at reference number 254, FIG. 15, will be approximately 70 to 80 feet, as shown in FIG. 15. It is assumed the north pole 11 on large device C will be located as shown in FIG. 15, as that is the orientation of said north pole at time of fusion igntion. Said craft would not have had time to change said orientation. The same applies to device B and north pole 11,

Ground cable 216 from device C on right connects to railroad track 214. A remote magnetic release, preferred embodiment, disengages ground cable connection 254b. A grounding device 212 from device B on left is connected to railroad track 210, FIG. 15. A remote release 254a, disengages ground cable 212 from railroad track 210, FIG. 15, in preferred embodiment for remote cable grounding release device.

The horizontal ferromagnetic aircraft, device A, has been located behind the opaque plasma cloud, approximately 100 feet from fusion reaction location.

Said aircraft plasmas 34, 34′ and 34a, 34a′, FIG. 1, are able to store all the fusion energy produced, as said plasmas are able to store said energy with almost unlimited capacity to store said produced fusion energy, in said rotating plasma vortices.

The penultimate achievement of this fusion system will be realized when the induced Larmor orbiting particle field tightens around said fusion spherical plasma 170, FIG. 12A, upper diagram, and then said induced Larmor orbiting particle field is surrounded by said electric current 186, FIG. 12A, upper diagram, and further surrounded by said raised applied field electric current 14, FIG. 11A, said current combines with, and into said induced field electric current, and is surrounded by said applied field Larmor orbiting particle field 34, 34a and 34′, 34a′, FIG. 1. Said applied Larmor orbiting particle field also tightening with time, and now tightening around all of said surrounding fields. The necessary pressure and temperature for ignition will be reached. In the event, that it is not reached, ignition can be accomplished by means of said hi-power laser, and, or neutral beam. The small aircraft will be required to use the plasma gun to remain stationary aloft, due to loss of said applied field electric current. During said stationary, vertical condition, craft ailerons can be used to stablilize craft.

After the aircraft loses its ferromagnetism due to high fields, the plasma will undergo a seeming change in its shape. This is due to the craft electric field increasing around the tungsten based annular ring of blades, and the craft magnetic field around said blades, though it will still possess the same north and south pole orientation, said magnetic field is now oriented around the annular ring of blades, as opposed to the previous orientation around the aircraft. Said new magnetic field will stretch beyond the end of the ring of blades, and consequently, said aircraft plasma field will also stretch out at the ends of said ring of blades, the annular ring of blades. The electric field now determines the aircraft plasma shape, the electric field in the diamagnetic plasma, and the electric field, particularly, around said annular ring of blades, with its now altered plasma configuaration.

With loss of ferromagnetism, the aircraft will still be able to fly, though some loss of altitude may result in a temporary requirement for readjustment.

I claim:

1. A multi-functional aircraft comprising: a ferromagnetic body hull, an annular ring of blades arrayed around said aircraft, said array of blades also called ailerons, before said blades are wrapped by uninsulated field windings, said blades are called blade cores, blade cores, uninsulated field windings, an array of ailerons, an array of large capacitors and an array of small capacitors, field windings connected by conducting wires to an array of capacitors located within the interior of said aircraft, a method of producing free ions, free ions are produced on the current carrying field winding surfaces of the annular ring of blades, also called a bladed ring assembly, said annular ring of blades arrayed around the circumferential midsection of the aircraft, a method whereby ions are released from said uninsulated field winding surface areas, and then, said ions are energized and projected from the blade surfaces with a Lorentz force at right angles to the craft magnetic and electric fields, said fields at right angles to each other, an array of capacitors,
and then, said ions are projected into perpendicular, diamagnetic Larmor orbiting particle fields around the aircraft, perpendicular fields within the applied magnetic field of the aircraft, an electric wiring system, an electric system, a method whereby said Larmor gyro orbiting particle fields form funnel shaped plasma vortices above said annular bladed ring, and below said bladed ring, within the aircraft applied-magnetic field formed upon starting aircraft, by a method utilizing remnant magnetism in said aircraft, and from the capacitance and inductance systems in the craft oscillatory circuit, a top plasma vortex, a bottom plasma vortex, an applied magnetic field, an inductance system, an oscillatory circuit, a capacitance system, resistance from said tungsten uninsulated field windings connected to a copper wire based aircraft electric system, all of the aforesaid are claimed, and the following also are claimed,
a method whereby said aircraft can be lifted off the earth, other surface, and become airborne, a method whereby said craft will be raised to high electromagnetic fields, the Larmor orbiting particles are, in effect, the electric coil in an electromagnetic, and the ferromagnetic craft is, the magnetic core inside the electromagnet, the Larmor orbiting particles are increasing in speed to the speed of light, at the same time, the ferromagnetic hull of the aircraft is being raised to high fields, said high magnetic fields translate into high electric fields, a large amount of electric energy is produced within these electromagnetic fields, said energy is stored in the array of capacitors within the aircraft, and within the craft inductance system, and within the craft orbiting particle fields, the plasma vortices and the particle fields are diamagnetic, field windings, uninsulated conducting field windings, the aircraft, a fluctuating direct current with an alternating current component within an oscillatory circuit possessing an inductance coil and an array of capacitors,
also claimed, tungsten uninsulated field windings connected to an electric wiring system containing conducting wires, said craft has few moving parts except for a plurality of axels pivotally connected to the blades, axels fixed in place, and at the other end from attachment to the blades end, axels connected to an interior blade attachment ring, blade attachment ring, also fixed in place, and also does not move, other than electrically rotates the axels, which rotate the blades, blades used as ailerons, blades used as proplellers underwater, other than the axels, the craft has no moving parts, said blades when turned by said axels will also move, a craft not requiring fuel to be provided for the craft to operate, ions produced on the uninsulated field windings as the fuel for the aircraft, electrons as fuel for aircraft, an array of axels,
plasma obtained from the atmosphere as the fuel for aircraft, and plasma as the fuel required for travel in space by means of a particle propulsion system in space, plasma as fuel required for submersible propulsion underwater, propulsion underwater by means of a particle propulsion system, and propulsion underwater by means of accelerated plasma, an on-board electrolysis system to electrolyze water and seawater,
axels that rotate individually, or synchronized, axels fixed in place, blades rotated by axels, a blade attachment ring, a means for navigation, a means for navigation, to include; a flight control system, or systems, aircraft instruments, gauges for aircraft flight, a navigation and control system, a navigation system utilizing ailerons operating within moving charged particles, said charged particles are rotating around the aircraft within the atmosphere, a flight control system, instruments and gauges for aircraft control, a navigation and control system, a flight system utilizing ailerons possessing an electric charge within rotating vortices comprised of moving charged particles,
an array of small capacitors arrayed around an aircraft central shaft,
said shaft also serving as the crew access tube, said shaft also serving as containment tube for the inductance coil, said shaft also serving as a pressure release tube for a B-11 istope ion nuclear fusion reaction on the top of the ferromagnetic craft, on the roof, said radiation reaction being essentially radiation free, and with negligible radiation being produced, a vacuum area, said vacuum area includes area between said aircraft hulls to include area containing the array of capacitors, a vacuum area as a dielectric permitting a high breakdown voltage for said capacitors, a means of propulsion by use of said rotating plasma vortices, a means of propulsion by use of said plasma gun, rotating plasma vortices as a means of propulsion, a plasma gun,
capacitors as electrodes as a means of propulsion,
Propulsion by means of propellers to include conducting propellers transferring an electric potential to conducting water, and by means of the craft magnetic and electric fields, reacting against the conducting water with a Lorentz force directed at the conducting water from the craft, the craft magnetic and electric fields being at right angles to each other, and the Lorentz force being at right angles to the electric field and the magnetic field of the craft, a method for forming aircraft applied magnetic field upon starting aircraft,
said propulsion systems include navigation systems utilizing directional control of said propulsion systems, secondary navigational or propulsion systems being ailerons utilzed as propellers underwater for navigation, for propulsion, a combination thereof, in an atmosphere plasma propulsion can be utilized, movement by means of capacitors, movement by means of a rotating plasma vortex mode of propulsion, all combinations of propulsion and navigation systems cited, said aircraft as a lifting device, or as a boring device,
a method of charging the capacitor plates with plasma for particle propulsion in space, by means of rotating said disengaged plates beneath said annular ring of blades of said aircraft, said bladed ring assembly encircling the aircraft is also called an annular ring, whereby said plates will absorb and store plasma for particle propulsion in space, a system to create an artificial atmosphere by means of utilizing an electrolysis system within said aircraft, a means of navigation underwater by use of said blades as rotating propellers, alternate means of propulsion, nozzles to extinguish incipient combustion or fire, on said blades, use of the aircraft for vertical takeoff and landing, a means whereby the aircraft are rendered invisible to visible and electromagnetic radiation due to the plasmas being opaque by nature to penetration by electromagnetic radiation, a means whereby by surrounding a craft in plasma vortices, the craft is rendered opaque to electromagnetic radiation, to include the radiation in the visible spectrum,
a means of viewing through said opaque plasma at magnetic poles where light is polarized, by means of using an antenna on roof of the aircraft, or viewing outside the opaque to electromagnetic radiation plasma by means of a trailing wire hung beneath the bottom plasma vortex, capability of said aircraft to be used within radiation belts above the earth, not otherwise safe to enter for even a limited period of time, capability of the aircraft to remain in said radiation belts for extended periods of time, capability of the aircraft to operate within outer space, to reach outer space, the exosphere and above, utilizing the same fuel, said fuel being energized ions utilized within the atmosphere on earth, or underwater on earth, and upon reaching outer space, to utilize a particle propulsion system for propulsion, a method for increasing the ferromagnetic magnetizm of the aircraft body hull, said craft is claimed as a decontamination device as it produces clean energy. A means of propulsion, now possible due to craft high fields, by positioning craft electric field at right angle to earth magnetic field, and increasing strength of said electric field, thereby, accelerating aircraft away from earth magnetic field, and away from surface of earth,
an annular ring of blades, said annular ring of blades is also called blade assembly ring, said annular ring of blades due to sharpening of the longitudinal edges of said blades, said sharpended edges will experience an electric wind effect, due to an electric wind effect, an electric current will be enabled to rotate around the peripheral midsection of said aircraft, the electric current formed primarily in the process of formation of plasma by the current in the field windings around said blades,
a plasma gun with a large pulsed current, and with a Lorentz force, said plasma gun also receiving a source of plasma from off said annular ring of blades connecting with said plasma gun, said ring of blades encircling said aircraft, said plasma being further accelerated by the diamagnetic plasma electric current entering said plasma gun with said plasma off said annular ring of blades,
Some of said propulsion systems, though widely known, were not heretofore feasible, but are now possible due to high field conditions attained by said aircraft,
said aircraft will possess aircraft controls based on the same general principles pertaining to other aerodynamic aircraft, to include jet aircraft, in effect, the aircraft is electrically controlled, aircraft pilots will be able to fly and operate this aircraft within the atmosphere, within an underwater environment in which said aircraft can operate, knowledge possessed by naval submarine pilots, will permit rapid comprehension of operation of said craft as a submersible craft, knowledgeable plasma engineers will accompany the craft as an aircraft, a submersible craft, and as a space craft,
in outer space, the exosphere and above, said aircraft used as a space craft will require celestial navigation, said knowledge is extant at this time, the aircraft used as a space craft, will utilize particle propulsion from plasma stored in said capacitors, metal ions, opposing capacitors of opposite charge, with an alternating current, will propel the particles in space, in space a co-axial rail accelerator can be utilized, said system is possessed by the aircraft, said retracted blades within aircraft, possess this capability, particle propulsion by expelling particles with a repulsive charge, can be utilized in space, ion space,
a specially trained navigator for celestial navigation will be required, extant life support systems will be utilized, to include, recycled air systems, recycled water systems, food stores of dehydrated items and canned items, to last duration of trip, and a store of DVD's to last duration of trip, artificial gravity has to be induced by using small on-board machines, said machines have to be used daily,
a method of charging said capacitor plates with plasma for particle propulsion in space and underwater, by means of disengaging capacitors, and rotating said plates beneath the annular ring of blades, said disengaged plates will, thereby, absorb and store metal ions as plasma for particle propulsion in space, or underwater, said rotation of plates within the craft magnetic field induces a circular electric current within the plates, enabling plasma to be stored.

2. The aircraft as defined in claim 1, wherein hull of said smaller aircraft is comprised of the material chromium steel.

3. The aircraft as defined in claim 1, wherein said array of capacitors are comprised of the material aluminum.

4. The aircraft as defined in claim 1, wherein said inductance coil is comprised of thick coils.

5. The aircraft as defined in claim 1, wherein said plurality of blades in said bladed ring assembly, comprises approximately 32 blades.

6. The aircraft as defined in claim 1, wherein said blade cores are comprised of the materials cobalt, tungsten, zirconium.

7. The aircraft as defined in claim 1, wherein said uninsulated blade field windings around said blade cores are comprised of the material tungsten.

8. The aircraft as defined in claim 1, wherein said plurality of capacitors consists of approximately 32 large capacitors and eight small capacitors, said 32 large capacitors comprise approximately 64 large capacitor plates, and said eight small capacitors comprise approximately 16 small capacitor plates.

9. The aircraft as defined in claim 1, wherein said capacitors are connected in parallel.

10. The aircraft as defined in claim 1, wherein said means for navigation in the atmosphere will comprise said conducting ailerons operating by reacting against a field of highly charged particles.

11. The aircraft as defined in claim 1, wherein said capacitors utilize titanium dioxide compound as a dielectric.

12. The method of claim 1, wherein a method for charging said capacitor plates with plasma, metal ions, for particle propulsion in space and underwater, comprises,
(a) by means of disengaging said capacitor plates within a gaseous atmosphere, and,
(b) rotating said plates beneath the craft annular ring of blades, while said aircraft is stationary and aloft, whereby,
(c) said plates will absorb and store plasma as metal ions for particle propulsion in space or underwater, moving in said craft magnetic field, heat is generated due to induced electromotive force, and electric eddy currents flow in plates, storing plasma from atmosphere, said plates turning, rotating, as they rotate circumferentially around the bottom of said aircraft.

13. The method of claim 1, wherein a method of forming said aircraft applied magnetic field upon starting aircraft operation, will comprise the steps of:
(a) by means of utilizing remnant magnetism remaining within the aircraft ferromagnetic, chromium steel hull, from last period of operation, and,
(b) by utilizing the stored energy in the capacitance and inductance system, said system upon being put into operation, will therein,
(c) form a north pole at one end of the inductance coil, and a south pole at the opposite end, thereby,
(d) forming an applied magnetic field around said aircraft.

14. The method of claim 1, wherein a method for producing said aircraft rotating top and bottom plasma vortices will comprise the steps of:
(a) utilizing uninsulated field windings comprised of the material tungsten, and electric current to said field windings directed through insulated copper wires from an array of capacitors, resistance will be created in the less conducting tungsten wires, creating high temperatures,
(b) said high temperatures and the high voltage from capacitors, will occasion the release of free ions from the uninsulated tungsten field winding surfaces,
(c) said high temperatures on the tungsten wire surfaces in the process of producing ions, will produce an abundance of electrons, and consequent diamagnetic electric plasma current around the circular annular ring,
(d) at a voltage recognized to create charged particles, ions will be energized and depart the field windings as charged particles, with a Lorentz force at right angles to the electric and magnetic fields of the craft, said fields being at right angles to each other,
(e) utilizing said annular ring of blades with sharpended longitudinal sides permitting an electric wind effect between blades, said blades will thereby function as the base for a rotating circular ring current around said aircraft, and through and on top surfaces of said annular ring of blades, said current comprising released electrons in the process of forming said plasma vortices, and plasma moving diamagnetic with electric current around said aircraft,
(f) the aircraft electric system controls the amount of energy going to or from the field windings, by this means the electric system controls the amount of energy going into the forming plasma vortices, by means of direct input of energy through the field windings to the plasma, and thereby controls the energy in the vortices, and the rate of rotation of the vortices, and consequently, the speed of the aircraft,
(g) as the plasma in the vortices is a current carrying medium, the diamagnetic plasma current can receive direct electric current to this conducting medium,
(h) and, the converse is also true, in the same manner electric current can be removed from the diamagnetic plasma current to the capacitance and inductance systems, slowing the craft,
(i) at a voltage to the field windings recognized to free ions, ions will be energized and depart the field windings, said ions now charged particles are then projected into perpendicular gyro orbiting Larmor orbiting particle fields around the aircraft, forming a diamagnetic moving plasma field, with a conducting plasma current, due to strong diamagnetic plasma current, said field is rotating in a counterclockwise turning direction, when rotation of the plasma vortices is viewed from the ground looking up at the bottom of the craft, the craft vortices will be turning counterclockwise to the right, whereby, by the right hand rule, motional direction for movement is upward, and, after absorption of energy after a nuclear fusion reaction, by said plasma vortices, and without use of said plasma gun, the craft will lift off earth's surface,
(j) and, by positioning craft in desired direction of movement by means of said ailerons, and by increasing energy to said vortices, craft can be accelerated in desired direction of travel, without assistance of said plasma gun,
(k) Prior to absorption of energy from a nuclear fusion reaction, ascent of said craft will have to be facilitated by use of said plasma gun directing plasma through the inductance coil to gain ascent, and then use of said plasma gun in addition to plasma vortices, to accelerate craft in direction of travel.

15. The method of claim 1, wherein a method for increasing aircraft electromagnetic fields, will comprise the steps of:
(a) upon starting operation of aircraft, electric energy stored in the capacitance system will be directed through copper wiring to the aircraft electric wiring system to tungsten wiring comprising field windings around the bladed ring assembly around said aircraft,
(b) said electric current through the lesser conducting tungsten field windings, will raise the temperature of said field windings to a high temperature, thereby releasing ions and electrons from said field winding surfaces, said released particles will be raised to high energy levels by the electric current in said field windings, said energized particles will be projected by a Lorentz force at right angles to the craft electric and magnetic fields, said fields being at right angles to each other,
(c) whereby, said projected particles will be projected into Larmor gyro orbiting particle fields around the aircraft within aircraft applied magnetic field,
(d) whereby, by means of said orbiting particles, the aircraft ferromagnetic hull will be raised to high fields, similar to the electric coil around a ferromagnetic core in an electromagnet, and said core will be raised to high fields upon transmission of an electric current through said conducting coil,
(e) whereby, as said orbiting particles are increasing in speed to the speed of light, receiving energy from said applied magnetic field as well, said aircraft ferromagnetic hull will be raised to high magnetic fields, which translates into high electric fields and potential for high electric current.

16. A method to accelerate plasma ejected into an inductance coil within an oscillatory circuit by a plasma gun with a large pulsed current, a Lorentz force, and, with a large supply of plasma, from an annular ring of blades encircling said aircraft, also called ailerons, said conducting plasma also being accelerated by a large amount of electric current moving within the plasma, as a means to assist in lifting said aircraft off the earth, to become airborne, comprising:
(a) ejecting said plasma into said inductance coil by means of said plasma gun, whereby,
(b) the north pole in said inductance coil will repel said conducting plasma, and
(c) the south pole will attract said conducting plasma, whereby,
(d) said plasma will be increasingly accelerated by said south pole attracting said conducting plasma, whereby,
(e) said plasma will be further accelerated by the negatively charged electromagnetic energy within said inductance coil, whereby,
(f) said accelerated plasma will be ejected from bottom of said craft with considerable force, and,
(g) said craft, assisted by craft lifting, rotating plasma vortices, and
(h) said craft assisted by plasma, accelerated by said inductance coil, and ejected with force, and
(i) said craft assited by repulsive, positive south pole of craft, repulsing a positive charged earth, whereby,
(j) said craft will be enabled to lift off the earth, and become airborne.

17. An electrolysis system, FIG. 12E, within said craft comprising barrel shaped containers of water, a container of boron B-11 isotope ion solution, electrode to electrolyze said water, a system for vaporization to obtain said B-11 isotope ion from borax, preferred source, seawater is also a recommended source, a method to accelerate ions in said electrolysis system prior to said ions exiting roof electrodes on top of said aircraft, FIG. 11A, said ions will exit funnel shaped spirals within an induced magnetic field formed on roof of said aircraft, a method for forming said induced magnetic field, wherein said exiting particles from said electrolysis system will form into a fusion spherical plasma on roof of said aircraft, within a tightening induced Larmor orbiting particle field, a method for forming said induced Larmor orbiting particle field, and a method whereby said fusion spherical plasma can be formed by said particles exiting at correct electrode exits on roof of aircraft to obtain correct opposing charge combinations.

18. The method of claim 17, wherein a method for forming said induced Larmor orbiting particle fields comprises,
(a) raising said pyramid shaped column with a glass ball electrode on top, whereby,
(b) an induced magnetic field is formed on top of said ferromagnetic aircraft, or other diamagnetic aircraft, wherein,
(c) an induced Larmor orbiting particle field around said fusion spherical plasma is also formed, said induced Larmor orbiting particle field is within said induced magnetic field.

19. The method of claim 17, wherein said exiting particles from said electrolysis system onto roof of said aircraft, form into a fusion spherical plasma within,
(a) an induced Larmor orbiting particle field, within
(b) an induced magnetic field, within a larger applied magnetic field, and,
(c) an induced electric current within an induced electric field, and also existing along with said fields, an,
(d) expanded magnetic field, and an, expanded electric field, with an,
(e) expanded electric current with the expanded electric field, said expanded electric current cutting the fusion spherical plasma at its midpoint, said
(f) expanded electric current is, in effect, uplifted to the center, and around said fusion spherical plasma.

20. The method of claim 17, wherein a method of forming a fusion spherical plasma on the roof of said aircraft, by means of said electrolysis system within an induced magnetic field, within an induced Larmor orbiting particle field, comprises,
(a) projecting exiting particles through electrode apertures on roof of said aircraft as depicted in FIG. 11A, as opposed,
(b) to assumed particle exits as depicted in FIG. 11B, due to,
(c) requirement for opposing charge combinations for exiting particles through said electrode apertures to be, exiting particles at electrode 154 are of a positive charge, exiting particles at electrode 158, the B-11 isotope ion exit, are positive and exiting particles at exit electrode 164 are positive, the resulting repulsive force will isolate the B-11 isotope ion, and repel positive particle in electrode 154 to combine with negative particle in electrode 152, a positive particle in electrode 164 to combine with negative particle in electrode 160, said two non-identified electrodes heretofore in this description, electrode 162 and 156 will also combine, said successful combinations are due to final physical crossing of tubular exits as shown in FIG. 11B to those as shown in FIG. 11A, showing successful combinations,
(b) whereby, said particles will form into said fusion spherical plasma within said induced magnetic field, within said induced Larmor orbiting particle field.

21. The electrolysis system as defined in claim 17, wherein said smaller and larger columns are both comprised of the material translucent, shock and fracture resistant, laminated glass.

22. The electrolysis system as defined in claim claim 17, wherein said electrolysis electrodes are comprised of the material platinum, for decomposing by electrolysis.

23. The method of claim 17, wherein a method for accelerating said particles within said large tubular columns comprises,
(a) rotating said particles around a ferromagnetic core, within a larger tubular column, thereby,
(b) energizing said ferromagnetic core, and,
(c) increasingly accelerating said particles simultaneously.

24. A nuclear fusion reaction process utilizing said smaller ferromagnetic aircraft and two or more larger magnesium aluminum aircraft, to produce energetic charged particles, a method to accomplish ignition of a formed fusion spherical plasma with two or more larger magnesium aluminum aircraft, and a method to contain and store said produced fusion energy, mostly energetic charged particles,
said nuclear fusion reaction can only take place at high temperatures, which this nuclear fusion reaction system will achieve, this fusion reaction system will reach temperatures required for said nuclear fusion reaction, wherein, the reacting nuclei will have the high energies needed to overcome mutual electrostatic force of repulsion, which is
the repulsion exerted by a charged particle on another charged particle, and this system will contain all of the energy produced within the top and bottom vortices of said aircraft, FIG. 15.

25. The method of claim 24, wherein a method to accomplish ignition of said fusion spherical plasma with two or more larger, magnesium aluminum hulled aircraft, comprises the steps of:
(a) positioning said two or more larger magnesium aluminum hulled aircraft, perpendicular and opposing on each side of said fusion spherical plasma, and also, said larger craft, perpendicular to said smaller ferromagnetic hulled horizontal aircraft, relative to earth 76, FIG. 14, and by,
(b) positioning the rotating plasma vortices on the top surfaces of the three aircraft, touching, whereby,
(c) the top rotating plasma vortex on the larger aircraft will be intersecting, each vortex will be rotating in a different direction, FIG. 12B,
(d) each of said aircraft will possess a formed spherical plasma, the smaller aircraft spherical plasma, alone, possesses a fusion spherical plasma 170, FIG. 12A, upper diagram,
(e) said induced magnetic field has raised the top rotating plasma vortex of said smaller aircraft, above said induced, and, or, expanded magnetic field,
(f) top plasma vortices of said two larger aircraft are directly intersecting,
(g) the plasma vortices of the two larger aircraft are now exerting pressure on the central fusion spherical plasma, from opposite sides,
(h) said fusion spherical plasma is now completely encircled by tightening induced Larmor orbiting particle field 182, FIG. 12A, upper diagram,
(i) and, said tightening induced Larmor orbiting particle field around said fusion spherical plasma, is now surrounded by induced electric current 186, FIG. 12A, upper diagram, squeezed into and with applied field electric current 14, FIG. 11A, bereft of said applied field electric current, said small craft is using the craft plasma gun 64 to stay aloft, using said craft ailerons to stabalize craft, said applied field electric current was raised when applied magnetic field expanded at time induced magnetic field induced,
(j) and, said induced, tightening electric current with said raised applied field current, is now surrounded by said applied field Larmor orbiting particle field 34, 34a and 34′, 34a′, FIG. 1, released and drawn in by said induced magnetic field, and now tightening around said combined electric currents and said induced Larmor orbiting particle field beneath said electric currents, and all of said currents and fields are now applying pressure and increasing temperature on said underlying fusion spherical plasma,
(k) each of said spherical plasmas is rotating in a different direction, FIG. 12B,
(l) each of said spherical plasmas is comprised of rotating charged particles, the particles in each plasma are rotating in different directions than the particles in the other spherical plasmas,
(m) and, only the center fusion spherical plasma contains the B-11 isotope ions,
(n) if ignition does not spontaneously occur, hi-power laser can be utilized to effect ignition, and neutal beam can be utiiized to effect ignition,
(o) prior to beginning fusion process, said large craft have to be grounded to separate locations, two separate sets of railroad tracks as indicated in FIG. 14, said smaller aircraft is grounded to a hi-power tension line in FIG. 14, said grounding attachments can be attached and disengaged remotely in preferred embodiment,
(p) whereby, ignition of said fusion spherical plasma will be effected, all aircraft being grounded as indicated in FIG. 14,
(q) moment of ignition is indicated in FIG. 14, after,
(r) said large aircraft are almost instanteously moved to locations indicated in FIG. 15, the high magnetic fields produced by said fusion reaction, will immediately render the ferromagnetic craft vulnerable to loss of said craft ferromagnetism, thereby necessitating immediate departure of said smaller ferromagnetic aircraft at moment of ignition, to a distance of approximately 200 feet.

26. The method of claim 24, wherein a method to contain and store said produced fusion energy, mostly energetic charged particles, within said plasma vortices of said larger magnesium aluminum hulled aircraft, comprises the steps of:
(a) after said nuclear fusion reaction, said larger aircraft, aircraft B and aircraft C, also called device B and device C, will store said produced fusion energy, mostly energetic charged particles, within said aircraft plasma vortices, energy is stored continuously,
(b) as said aircraft move with the expanding plasma formation as it expands as shown in FIG. 15, until final dissolution of said plasma formation 230, also called plasma cloud, at which time, remaining energy, mostly electrostatic particles, will be absorbed by oppositely charged rods extending from each craft,
(c) upon final collapse of said plasma formation, a bolt of positive, green electricity will be attracted to outstretched lightning rod of negatively charged rod, and a bolt of usual colored negative electricity will be attracted to outstretched positive rod, said final bolts of electricity can be stored or grounded,
(d) all of said produced fusion energy has been stored in the plasma vortices of said aircraft B and aircraft C,
(e) said produced energy can remain stored in said aircraft vortices, as plasmas are capable of storing an almost unlimited amount of energy, or,
(f) said energy can be microwaved or sent by waveguide to an energy storage location.
